(19) United States
(12) Patent Application Publication
(10) Pub. No.: US 2026/0121556 A1
(43) Pub. Date: Apr. 30, 2026

(54) ORAL CARE DEVICE AND CONTROL METHOD FOR MOTOR THEREOF

(71) Applicant: GUANGZHOU STARS PULSE CO.,LTD., GUANGZHOU (CN)

(72) Inventors: WEI CHEN, GUANGZHOU (CN); YAGUI LI, GUANGZHOU (CN)

(21) Appl. No.: 19/432,975

(22) Filed: Dec. 25, 2025

Related U.S. Application Data
(63) Continuation of application No. PCT/CN2025/101735, filed on Jun. 18, 2025.

(30) Foreign Application Priority Data
May 30, 2025 (CN) 202510729582.5
Jun. 28, 2024 (CN) 202410862859.7
Jun. 28, 2024 (CN) 202410862901.5

(51) Int. Cl. H02N 2/00; A46B 13/02; A46B 15/00; A61C 17/34

(52) U.S. Cl. CPC H02N 2/0095; A46B 13/023; A46B 15/0006; A61C 17/3418; A61C 17/3481

(57) ABSTRACT

An oral care device and a control method for a motor thereof are provided. The oral care device includes a motor, and the motor includes a rotor. The control method includes: obtaining a drive signal, where the drive signal includes sweeping signals, and each of the sweeping signals includes vibration signals; controlling the rotor to perform reciprocating vibrations relative to a reference axis based on the drive signal, and changing a position of the reference axis to increase a vibration coverage range of the rotor; where the reciprocating vibrations include linear vibrations or rotational vibrations; and controlling the rotor to vibrate based on the vibration signals; and controlling the rotor to vibrate based on the sweeping signals, and changing the position of the reference axis to form a sweeping motion of the rotor. The drive signal is a predetermined signal.

### TECHNICAL FIELD

The present disclosure relates to a field of oral cleaning technology, and in particular to an oral care device and a control method for a motor thereof.

### BACKGROUND

Electric toothbrushes have become a common tool for improving tooth cleaning efficiency and overall oral health. However, the electric toothbrushes generally use a sonic motor to drive a rotor to clean the teeth and mouth. A vibration amplitude of conventional electric toothbrushes is relatively small, resulting in a limited vibration coverage area. Consequently, a user needs to frequently reposition the conventional electric toothbrush to clean entire tooth surfaces, which leads to missed tooth surfaces, thus reducing an overall oral cleaning effect.

### SUMMARY

Embodiments of the present disclosure provide an oral care device and a control method for a motor thereof. By controlling a rotor of the motor to vibrate to change a position of a reference axis of the rotor, a vibration coverage range of the rotor is significantly increased to improve an oral cleaning effect.

In a first aspect of the present disclosure, the present disclosure provides a control method for a motor of an oral care device. The control method comprises steps:

obtaining a drive signal, where the drive signal comprises sweeping signals, and each of the sweeping signals comprises vibration signals;

controlling a rotor of the motor to perform reciprocating vibrations relative to a reference axis based on the drive signal, and changing a position of the reference axis to increase a vibration coverage range of the rotor; where the reciprocating vibrations comprise linear vibrations or rotational vibrations; and controlling the rotor to vibrate based on the vibration signals; and controlling the rotor to vibrate based on the sweeping signals, and changing the position of the reference axis to form a sweeping motion of the rotor. The drive signal is a predetermined signal.

In a second aspect of the present disclosure, the present disclosure provides an oral care device. The oral care device comprises a processor and a memory. The processor is connected to the memory. The memory is configured to store executable program code; and the processor is configured to run a program corresponding to the executable program code by reading the executable program code stored in the memory, so as to execute the control method in the first aspect of the embodiment of the present disclosures or any possible implementation of the first aspect.

In the present disclosure, the drive signal that is predetermined is obtained, the rotor of the motor is controlled to vibrate back and forth relative to the reference axis based on the drive signal, and the position of the reference axis is changed to increase the vibration coverage range of the rotor. In this way, the rotor is made to vibrate back and forth with a small amplitude relative to the reference axis, driving a brush head of the oral care device to vibrate back and forth with a small amplitude, thereby reducing irritation to sensitive teeth. Moreover, by changing the position of the reference axis, the vibration coverage range of the rotor is significantly increased, allowing the brush head to cover more tooth surfaces and reducing a frequency with which the user needs to manually move the oral care device. Therefore, when the user brushes his/her teeth, the brush head fully covers the tooth surfaces, ensuring an efficient oral cleaning effect.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of an oral care device according to one embodiment of the present disclosure.

FIG. 2 is a flow chart of a control method for a motor of the oral care device according to one embodiment of the present disclosure.

FIG. 3 is a schematic diagram of different vibration manners of the rotor according to one embodiment of the present disclosure.

FIG. 4 is a schematic diagram of a position of a reference axis during different vibration processes according to one embodiment of the present disclosure.

FIG. 5 is a schematic diagram of a vibration range and a sweeping range of the rotor according to one embodiment of the present disclosure.

FIG. 6 is a waveform diagram of the drive signal according to one embodiment of the present disclosure.

FIG. 7 is a schematic diagram of pulses of each of vibration signals in the drive signal according to one embodiment of the present disclosure.

FIG. 8 is another waveform diagram of the drive signal according to one embodiment of the present disclosure.

FIG. 9 is a waveform diagram of the drive signal after filtering and sampling according to one embodiment of the present disclosure.

FIG. 10 is a schematic diagram of change in the position of the reference axis during a vibration process according to one embodiment of the present disclosure.

FIG. 11 is another waveform diagram of the drive signal according to one embodiment of the present disclosure.

FIG. 12 is a schematic diagram of the change in the reference axis during different vibration processes of the rotor according to one embodiment of the present disclosure.

FIG. 13 is another schematic diagram of the change in the position of the reference axis during the vibration process according to one embodiment of the present disclosure.

FIG. 14 is another schematic diagram of the change in the position of the reference axis during the vibration process according to one embodiment of the present disclosure.

FIG. 15 is a schematic diagram of a system where the oral care device thereof is communicated with a terminal according to one embodiment of the present disclosure.

FIG. 16 is a block schematic diagram of a motor control device according to one embodiment of the present disclosure.

FIG. 17 is a block schematic diagram of the oral care device according to one embodiment of the present disclosure.

Realization of purposes, functional features, and advantages of the present disclosure is further explained in conjunction with embodiments and with reference to the accompanying drawings.

### DETAILED DESCRIPTION

Technical solutions in the embodiments of the present disclosure will be clearly and completely described below in conjunction with the accompanying drawings in the embodiments of the present disclosure.

Terms "first", "second", "third", "fourth", and the like in the specification, the claims, and the accompanying drawings are used to distinguish different objects, and are not used to describe a specific order. In addition, terms "have", "comprise", and any variations thereof are intended to cover non-exclusive inclusion, e.g., comprises a series of steps or units, processes, methods, systems, products, or devices, which are not limited to the listed steps or units, but may optionally further comprise steps or units not listed, or optionally further comprises steps or units inherent to the processes, methods, products, or devices.

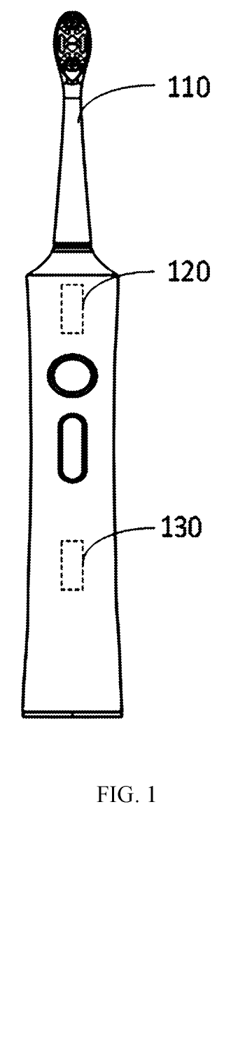

FIG. 1 is a schematic diagram of an oral care device according to one embodiment of the present disclosure. As shown in FIG. 1, the oral care device comprises a care element 110, a motor 120, and a control unit 130. The oral care device is a device capable of performing oral cleaning, including but not limited to an electric toothbrush. For ease of description, the embodiments are described using the electric toothbrush as an example.

The care element 110 is a brush head with bristles that directly contact teeth and the oral cavity to remove plaque and food debris. A design of the bristles generally takes into account a shape and an arrangement of the teeth to clean all tooth surfaces. The care element 110 is configured to generate a swing amplitude through vibrations of the motor 120, thereby breaking down the toothpaste on the care element 110 into fine foam, achieving deep cleaning of teeth gaps.

The motor 120 is configured to vibrate according to a drive signal input by the control unit 130, synchronously driving the care element 110 to swing with a certain amplitude. The motor is configured to drive the care element 110 to clean the teeth and the oral cavity. The motor 120 is a sonic motor configured to generate vibration according to the drive signal that is predetermined to achieve open-loop control.

The control unit 130 is disposed in an accommodating cavity of a handle housing and may be a microcontroller unit (MCU). The MCU is also known as a single-chip microcomputer or a single chip. The MCU appropriately reduces a frequency and specifications of a central process unit (CPU), and integrates peripheral interfaces such as memory, counter, USB, A/D conversion, universal asynchronous receiver/transmitter (UART), programmable logic controller (PLC), data memory access (DMA), and even liquid crystal display (LCD) drive circuits on a single chip to form a chip-level computer, which performs different combination controls for different application scenarios.

Specifically, the control unit 130 is connected to the motor 120. The control unit 130 is configured to send the drive signal (such as a PWM wave) to the motor 120 to control an output current of an H-bridge circuit, thereby driving a rotor of the sonic motor 120 to perform reciprocating vibrations relative to the reference axis according to the drive signal, and changing a position of the reference axis to increase a vibration coverage range of the rotor.

Optionally, the oral care device further comprises one or more indicator lights, a button, a display screen, a speaker, a motor, etc., which are not limited thereto.

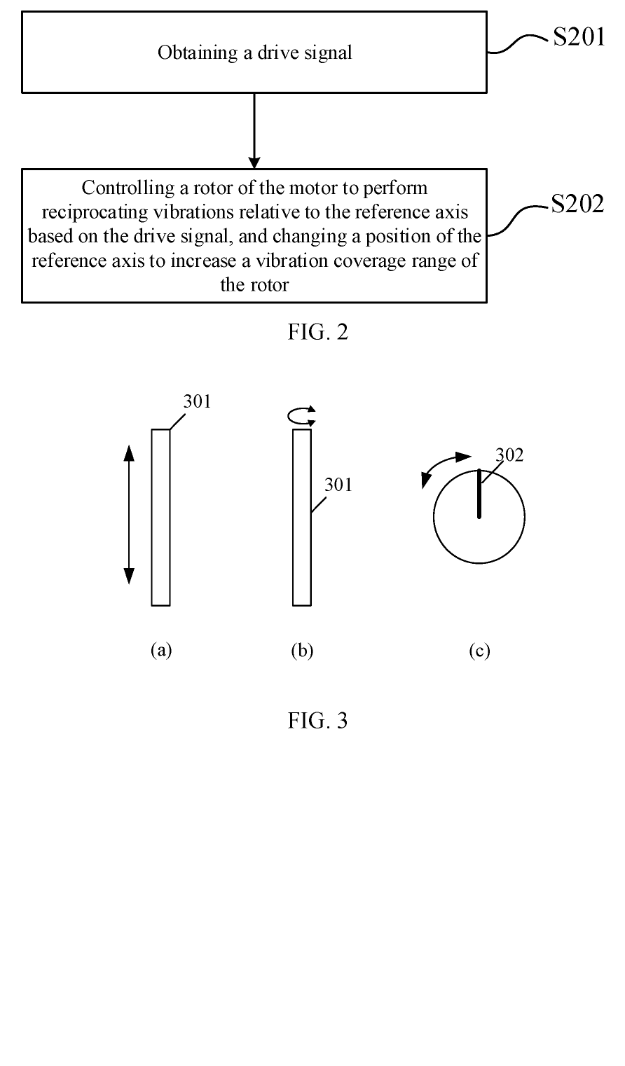

With reference to FIG. 1, a control method for a motor of an oral care device according to one embodiment of the present disclosure is introduced. FIG. 2 is a flow chart of a control method for a motor of the oral care device according to one embodiment of the present disclosure. As shown in FIG. 2, the control method comprises steps S201-S202.

The step S201 comprises obtaining the drive signal.

The step S202 comprises controlling the rotor of the motor to perform reciprocating vibrations relative to the reference axis based on the drive signal, and changing the position of the reference axis to increase the vibration coverage range of the rotor.

Specifically, the drive signal is a predetermined signal configured to control the motor and comprises parameters such as frequency and duty ratio. The motor of the oral care device adopts open-loop control. The rotor is controlled to vibrate through the drive signal. In the embodiment, the drive signal is not a single signal and is allowed to be adjusted or configured based on gear position, mode, or other methods, making the oral care device suitable for a wide range of applications.

Optionally, the step S202 of controlling the rotor of the motor to perform the reciprocating vibrations relative to the reference axis based on the drive signal, and changing the position of the reference axis to increase the vibration coverage range of the rotor comprises steps: controlling the rotor to rotate in a first direction based on a high level of each of the vibration signals, and controlling the rotor to rotate in a direction opposite to the first direction based on a low level or a reverse high level of each of the vibration signals, so that the rotor vibrates back and forth relative to the reference axis; and controlling the rotor to vibrate based on the vibration signals, and changing the position of the reference axis to generate a sweeping motion of the rotor, so as to increase the vibration coverage range of the rotor. The vibrations comprise linear vibrations or rotational vibrations.

The drive signal comprises sweeping signals, and each of the sweeping signals comprises vibration signals. The vibration signals are basic signals configured to drive the rotor to vibrate. By controlling each of the vibration signals, the rotor is controlled to perform a reciprocating vibration. Each of the sweeping signals is composed of the vibration signals and is configured to control an overall motion pattern of the rotor. By combining different vibration signals, the position of the reference axis is changed to achieve a sweeping effect. The motor is controlled based on the sweeping signals. The rotor not only performs periodic vibrations with a small swing amplitude, but also performs large-scale sweeping vibrations as the position of the reference axis changes.

In the embodiment, the drive signal is configured to control the reciprocating vibrations of the rotor relative to the reference axis. The reciprocating vibrations comprise linear vibrations or rotational vibrations. The linear vibrations refer to a reciprocating motion of the rotor along a straight line. That is, the rotor moves up and down or left and right along a fixed path, without involving rotation or curved motion. The drive signal is further configured to control the frequency (the number of reciprocating vibrations per second) and the amplitude of the rotor (a distance the rotor moves). The rotational vibrations refer to a reciprocating motion of the rotor axially rotating left and right. The rotational vibrations involve angular variation. That is, the rotor rotates back and forth within a certain range. The drive signal controls the frequency (the number of the reciprocating vibrations per second) and the rotation angle of the rotor (an angular range of a rotation of the rotor). In the embodiment, the reciprocating vibrations of the rotor drive the care element (such as the brush head) to vibrate left and right, thereby achieving oral cleansing. For example, an image (a) of FIG. 3 shows a linear vibration of the rotor. The rotor 301 (such as a motor shaft) is able to drive the care element (such as the brush head) to vibrate through reciprocating linear vibrations. Images (b) and (c) of FIG. 3 illustrate the rotational vibrations. The rotors 301 drive the care element to vibrate through the rotational vibrations. The image (c) is a top plan view of the image (b), and 302 is a schematic diagram of a motion trajectory of the rotor. 302 is a line connecting a rotation axis of rotor 301 to a selected fixed edge, which is conductive to illustration and description of the position or rotational direction of the rotor in subsequent drawings of the embodiments. In the embodiment, the rotational vibrations of the rotor is taken as a primary example for further description. A specific implementation of the linear vibrations of the rotor is the same or similar to that of the rotational vibrations of the rotor and is not further elaborated herein.

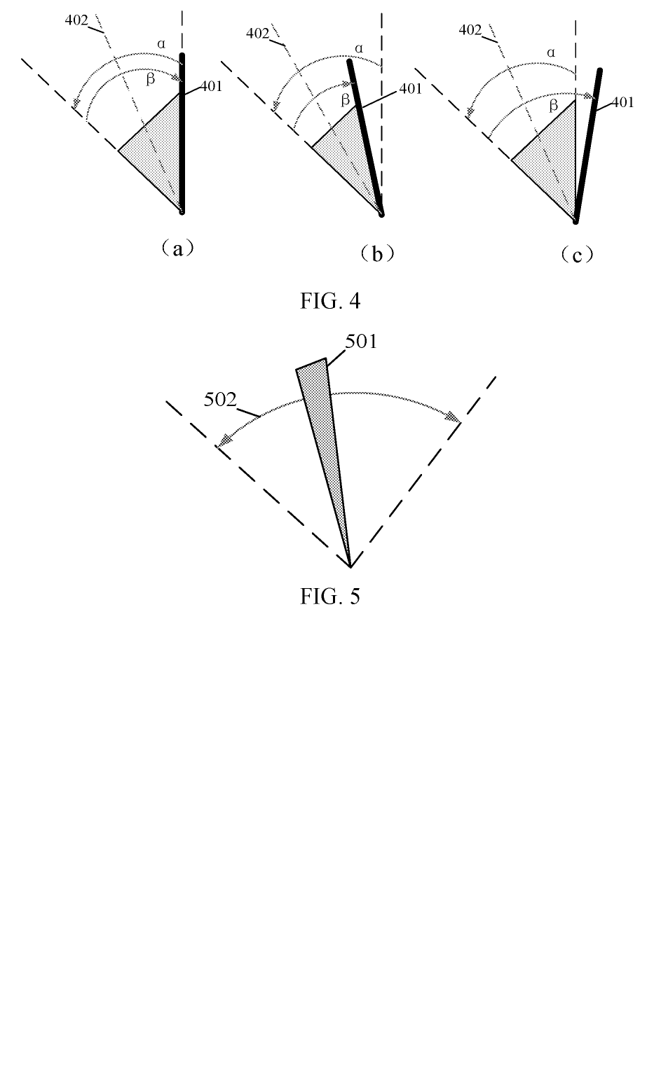

The reference axis is a position of a vibration center of a single reciprocating vibration of the rotor. For example, as shown in FIG. 4, the rotor 401 rotates in one direction under a control of the drive signal and then reverses in an opposite direction, thereby completing the single reciprocating vibration. The reference axis of the single reciprocating vibration of the rotor 401 is defined as the vibration center 402 of the rotor, and a vibration amplitude of the rotor is defined as an angle of an overlapping area (gray areas shown in FIG. 4) between a forward rotation and a reverse rotation of the rotor. A center position of each of the gray areas in FIG. 4 is the vibration center 402. As shown in image (a) of FIG. 4, when a forward rotation angle α and a reverse rotation angle β of the rotor 401 in the single reciprocating vibration are equal, the rotor 401 rotates α degrees from a starting position and then reverses to the starting position. The vibration center 402 of the single reciprocating vibration is the center position of the forward rotation of the rotor or the center position of the reverse rotation of the rotor. As shown in image (b) of FIG. 4, when the forward rotation angle α and the reverse rotation angle β of the rotor 401 during the single reciprocating vibration are inconsistent, and the rotor 401 is not fully reversed (α>β), after rotating from the starting position for α degrees, the rotor fails to reverse to the starting position. The vibration center 402 of the single reciprocating vibration is the center position of the reverse rotation of the rotor. As shown in image (c) of FIG. 4, when the forward rotation angle α and the reverse rotation angle β of the rotor 401 during the single reciprocating vibration are inconsistent, and the rotor 401 is over-reversed (α<β), after rotating from the starting position for α degrees, the rotor fails to reverse to the starting position. The vibration center 402 of the single reciprocating vibration of the rotor is the center position of the forward rotation of the rotor. It should be noted that the examples described above are merely for ease of describing the reciprocating vibrations of the motor and are not intended to be limitations. Those skilled in the art may use other descriptions to describe the reciprocating vibration of the motor or define the reference axis based on the embodiment.

In the embodiment, the position of the reference axis of the rotor during the reciprocating vibrations is controlled to change based on a single sweeping signal, and the reference axis is controlled to shift in any direction (left or right), thereby generating a sweeping vibration. For example, each of the sweeping signals comprises the vibration signals, and the rotor of the motor performs the reciprocating vibrations based on the vibration signals. While maintaining the reciprocating vibrations, the rotor changes the position of the reference axis through a combination of the vibration signals, thereby causing the rotor to change a vibration direction. For example, the rotor initially vibrates within a range of 5-8° from a datum axis, then changes to vibrate within a range of 7-10°from the datum axis. As the position of the reference axis changes, the sweeping vibration over a wide angle and range (e.g., -30° to 30°) is achieved. As shown in FIG. 5, 501 represents a vibration range of the single reciprocating vibration of the rotor, and 502 represents a sweeping vibration range of the rotor. The rotor continuously vibrates with a small amplitude within the sweeping vibration range, reducing irritation to sensitive teeth. Moreover, the sweeping vibration of the rotor significantly increases the vibration coverage range of the rotor, so that the care element covers more tooth surfaces, thereby reducing a frequency with which the user needs to manually move the oral care device. Therefore, when the user brushes his/her teeth, the brush head fully covers the tooth surfaces, ensuring an efficient oral cleaning effect.

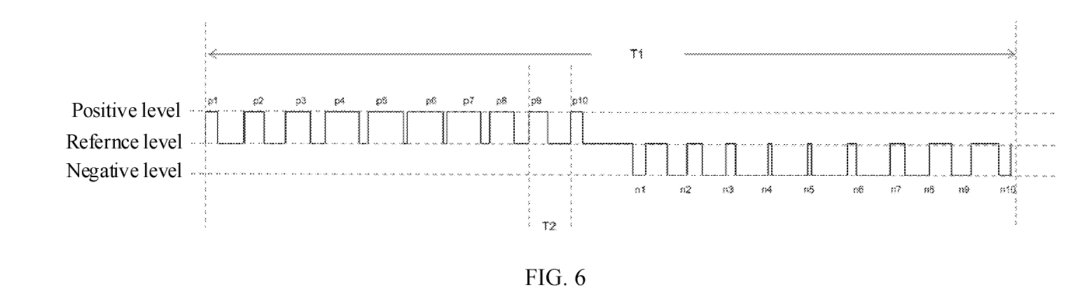

In some embodiments, each of the vibration signals is configured to control the rotor to perform the single reciprocating vibration, where each of the reciprocating vibrations comprises a forward rotation of the rotor away from the datum axis and the reverse rotation toward the datum axis. Each of the sweeping signals is configured to control the rotor to perform a single sweeping vibration of the sweeping vibrations, where each of the sweeping vibrations comprises a complete rotation of the reference axis, such as the reference axis rotating from the starting position to an ending position, or the reference axis rotating from the starting position in a certain direction and then returning to the starting position. For example, as shown in FIG. 6, a segment of the drive signal comprises a single sweeping signal of a T1 circle, and the T1 circle comprises the vibration signals of a T2 circle.

As shown in FIG. 6, each of the sweeping signals comprises the vibration signals, and each of the vibration signals comprises a high level (positive levels p1-p10 or a negative levels n1-n10) and a low level (reference level). The high level of each of the vibration signals is configured to control the H-bridge circuit to output a positive current or a negative current, thereby controlling the motion of the motor in a first direction. In the embodiment, the first direction towards either left or right. For example, each positive level in each of the sweeping signals controls the H-bridge circuit to output a positive current, causing the motor to rotate to the left. The negative level of each of the vibration signals in each of the sweeping signals controls the H-bridge circuit to output the negative current, causing the motor to rotate to the right. Under the reference level of each of the vibration signals in each of the sweeping signals, the H-bridge circuit does not output current, and the motor does not move or rotates toward the datum axis under an action of a reset mechanism. The datum axis is a fixed reference axis of the motion of the rotor. The datum axis is defined as a position where the rotor is stationary under the action of the reset mechanism, that is, an initial position of the rotor when it does not receive the vibration signals. The reset mechanism is configured to drive the rotor of the motor to reset to the datum axis. The datum axis is the fixed reference axis of the motion of the rotor, which may be a center axis or other fixed position within a movable range of the rotor. A relative position of the rotor or a relative position of the reference axis is determined according to the datum axis.

Specifically, for the drive signal, a common pulse width modulation (PWM) waveform is a square wave. During a square wave control cycle, two segments of back electromotive force (EMF) occur during return of a cogging torque swing motor to center. During the process, a reverse square wave control signal consumes some power to offset the reverse EMF, which requires a current greater than an ideal current to achieve a desired control effect. Furthermore, harmonic components generated by the drive signal that is the square wave when counteracting the reverse EMF caused by inertia increase motor losses, affecting a normal operation and efficiency of the oral care device. On this premise, in the embodiment, pulse widths of the vibration signals in the drive signal are controlled to periodically change according to a rule that increases first and then reduces. Therefore, the motor is allowed to adaptively obtain a desired output waveform at each moment as the pulse widths of the vibration signals change.

Furthermore, to more precisely control the pulse widths of the vibration signals according to actual usage requirements, the pulse widths of the vibration signal are periodically changed in a sine waveform. As the name suggests, the sine waveform is a mathematically defined sinusoidal curve. Because the sine waveform has a single frequency component, the sine waveform has low harmonic content and good waveform quality, which is conductive to reducing harmonic losses in the motor and other equipment. The vibration signals with the pulse widths that change according to the sine waveform produce a smoother and more precise output waveform for the motor, thereby enabling more precise motor control. In this way, when the vibration signals are configured to control the reciprocating vibrations of the rotor of the rotor, a softer sweeping vibration sensation is provided to the user.

In one optional embodiment, by generating a reference sine wave signal and a triangular wave signal, and modulating the pulse widths of the vibration signals through the reference sine wave signal and the triangular wave signal, the pulse widths of the vibration signals within the same circle periodically change according to the regularity of the sine waveform. In other words, in the embodiment, the drive signal is output by using sinusoidal pulse width modulation (SPWM).

Specifically, when outputting the drive signal through an SPWM pulse width modulation method, the reference sine wave signal and the triangular wave signal are first generated. The reference sine wave signal serves as a modulating wave, and the triangular wave signal serves as a carrier wave. A combined action of the reference sine wave and the triangular wave modulates and generates a series of vibration signals. The pulse widths (i.e., the duty ratio) of the vibration signals has a fixed amplitude and a variable width. For example, as shown in FIG. 7, a pulse width of an X1 vibration signal at a first dashed line from left to right is 22.2 milliseconds (ms), while a pulse width of an X2 vibration signal at a dashed line to the right of the X1 vibration signal is 28.1 ms. It is noted that the pulse widths of the vibration signals within a cycle change and tend to exhibit the sine waveform. It should be noted that due to the objective existence of capacitors and inductors, the waveform of the drive signal generated in actual scenarios may not completely conform to the theoretical ideal waveform, but may instead appear as a slightly square wave-like waveform as shown in FIG. 7.

Furthermore, when modulating the pulse widths of the vibration signals based on the reference sine wave signal and the triangular wave signal, the reference sine wave signal is compared with the triangular wave signal to obtain a comparison result, and the pulse widths of the vibration signals are modulated according to the comparison result. Specifically, when an instantaneous value of the reference sine wave signal is greater than an instantaneous value of the triangular wave signal, the high level is output; otherwise, the low level is output. The pulse widths being output change with an amplitude of modulated signals, forming a positive and negative alternating pulse sequence. After appropriate filtering, a generated pulse sequence exhibits an approximate sinusoidal waveform output. In addition, each of the pulse widths of the vibration signals pulse is able to be fine-tuned by adjusting a phase difference between the reference sine wave signal and the triangular wave signal, thereby achieving precise adjustment of a motor speed and a torque of the motor and improving the control efficiency of the motor of the oral care device.

In some embodiments, the triangular wave signal has bipolarity. A step of comparing the reference sine wave signal with the triangular wave signal to obtain the comparison result comprises: comparing the reference sine wave signal with a positive triangular wave signal in the triangular wave signal to obtain a positive half cycle signal of a current vibration signal of the vibration signals; and comparing the reference sine wave signal with a negative triangular wave signal in the triangular wave signal to obtain a negative half cycle signal of the current vibration signal.

Specifically, the triangular wave signal generated in the embodiment is a bipolar triangular wave. The bipolar triangular wave changes symmetrically between a positive voltage and a negative voltage, i.e., the triangular wave signal has the same amplitude and frequency in a positive negative half cycle thereof and a negative half cycle thereof, and a polarity of the amplitude and frequency in the positive negative half cycle thereof is opposite to that in the negative half cycle thereof. In this case, output voltage signals are controlled separately in each positive half cycle (when the voltage is positive) and each negative half cycle (when the voltage is negative). Specifically, by comparing the reference sine wave signal with the positive triangular wave signal in the triangular wave signal, positive half cycle signals of the vibration signals are obtained; and by comparing the reference sine wave signal with the negative triangular wave signal in the triangular wave signal, negative half cycle signals of the vibration signal are obtained. In bipolar SPWM control, the drive signal of the positive half cycle and the drive signal of the negative half cycle are also allowed to be adjusted separately to achieve more precise motor control.

In some embodiments, the control method further comprises: evenly dividing a voltage space plane into at least two fan-shaped areas. Each of the fan-shaped areas comprises a basic voltage vector and a zero vector adjacent to the basis voltage vector, and the basis voltage vector thereof and the zero vector thereof jointly synthesize a voltage vector. An action time of each basic voltage vector and each zero vector are controlled, so that the waveform of the drive signal is the sine waveform.

Specifically, in addition to outputting the drive signals using the SPWM pulse width modulation method, Space Vector Pulse Width Modulation (SVPWM) technology is also allowed to modulate the drive signal. The voltage space plane is evenly divided into the at least two fan-shaped areas. Each of the fan-shaped areas comprises the basic voltage vector and the zero vector adjacent to the basis voltage vector, and the basis voltage vector thereof and the zero vector thereof jointly synthesize the voltage vector. The SVPWM technology directly generates each voltage vector through the combination of space vectors in each of the fan-shaped areas, which is conductive to high bus voltage utilization and low output harmonic content.

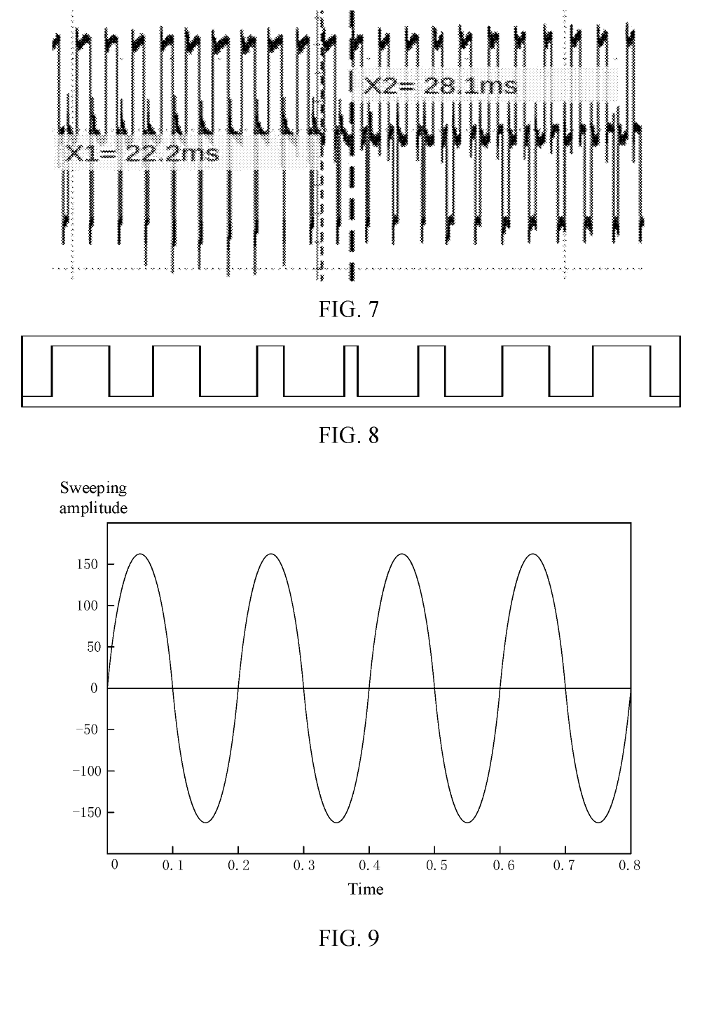

In the embodiments, single-phase SVPWM technology is specifically applied to control the drive signal. The single-phase SVPWM technology generally divides the voltage space plane into two or four fan-shaped areas to simplify control logic. When two fan-shaped areas are provided, the voltage space plane is divided into a positive half cycle and a negative half circle. The positive half cycle and the negative half cycle of the voltage space plane respectively correspond to a positive pulse and a negative pulse. When four fan-shaped areas are provided, the positive half cycle and the negative half circle of the voltage space plane are further subdivided to further improve control accuracy. As shown in FIG. 8, in a specific control process, by controlling the action time of each basic voltage vector and each zero vector, the drive signal with different pulse widths is synthesized, and the drive signal is further filtered and sampled to obtain the sine waveform as shown in FIG. 9.

In one optional embodiment, when using the SVPWM technology to output the drive signal through vector pulse width control, an audio signal commonly required is replaced with the voltage configured to control an output audio stream of the motor, essentially replacing the audio signal with an audio track drive signal. This audio track drive signal drives the motor to vibrate and produce sound, eliminating the need for a dedicated audio decoding hardware disposed in the oral care device. Instead, a vibration sound of the motor is directly configured as an operating sound of the oral care device. Furthermore, by precisely controlling a frequency and an amplitude of the audio track drive signal, specific sound or vibration effects are simulated or generated.

In some embodiments, considering that when a switching frequency of the sonic motor is below 10 kHz, the sonic motor generates significant electromagnetic noise, and when the switching frequency of the sonic motor is above 22.05 kHz, some signal points are discarded due to insufficient processing. Therefore, an execution frequency of the audio track drive signal is controlled within a range of not less than 10 KHZ and not greater than 22.05 KHZ, such as 10 KHZ, 12.5 KHZ, 13 KHZ, 22 KHZ, etc., so that the audio track drive signal is able to drive the sonic motor to vibrate and sound smoothly and coherently without generating large electromagnetic noise. In another optional embodiment, the audio track drive signal is obtained by sampling an audio track signal input to the motor, and a sampling frequency during sampling determines the execution frequency of the audio track drive signal. Then, the sampling frequency of the audio track signal is selected within the range of not less than 10 KHZ and not greater than 22.05 KHZ. For example, the sampling rate can be 10 KHZ, 12.5 KHZ, 13 KHZ, 22KHZ, etc., so that the execution frequency of the audio track drive signal is controlled within the range of 10 KHZ-22.05 KHZ.

In some embodiments, the motor comprises the reset mechanism. The rotor moves in a direction away from the datum axis under the high level of each of the vibration signals, and the reset mechanism drives the rotor to move in a direction toward the datum axis under a low level and/or a reverse high level of each of the vibration signals.

Specifically, the first direction is away from the datum axis, and the direction opposite to the first direction is toward the datum axis. When the single vibration signal is at the high level, the rotor moves away from the datum axis. When the single vibration signal is at the reverse high level, the rotor moves toward the datum axis. When the motor comprises the reset mechanism and when the single vibration signal is at the low level or the reverse high level, the reset mechanism drives the rotor to move toward the datum axis, thereby generating the single reciprocating vibration relative to the reference axis.

In some embodiments, the step of controlling the rotor to vibrate based on the sweeping signals and changing the position of the reference axis to form the sweeping motion of the rotor comprises: in each of the sweeping signals, controlling the rotor to rotate in the direction opposite to the first direction based on a low level and/or a reverse high level of a current vibration signal in each of the sweeping signals after controlling the rotor to rotate in the first direction based on a high level of the current vibration signal of each of the sweeping signals; and controlling the rotor to rotate in the first direction again based on the high level of a next vibration signal when the reverse rotation of the rotor is not in place, so as to change the position or a rotation angle of the reference axis.

Specifically, the positive high level of the current vibration signal controls the H-bridge circuit to output the positive current, thereby controlling the motor to rotate in the first direction. Then, the reverse high level of the current vibration signal controls the H-bridge circuit to output the reverse current, thereby controlling the motor to rotate in the direction opposite to the first direction. When the motor does not reverse to the starting position, the positive high level of the next vibration signal controls the H-bridge circuit to output the positive current, controlling the motor to rotate in the first direction again, making the forward rotation angle of the motor being different from a reverse rotation angle of the motor, thereby changing the position of the reference axis of the rotor. In the rotational vibrations, the position of the reference axis is represented by an angle between the reference axis and the datum axis. The datum axis is the fixed reference axis of the motion of the rotor. The datum axis may be a center axis of a movable range of the rotor or another fixed position. The relative position of the rotor or the relative position of the reference axis is determined based on the datum axis.

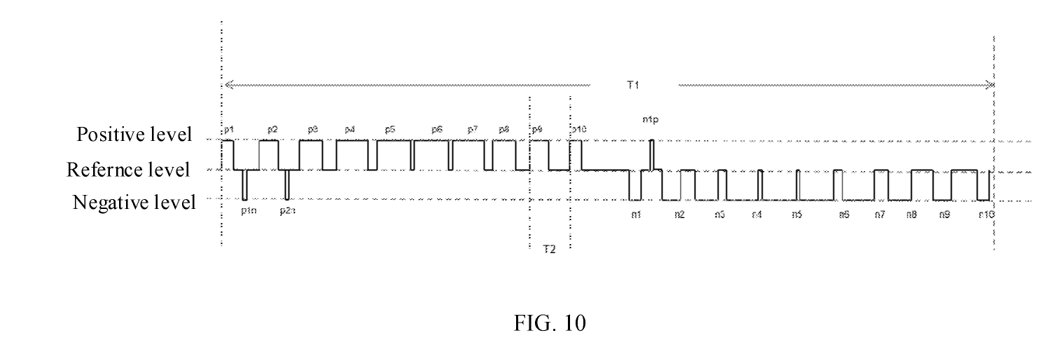

Furthermore, the first direction is the direction away from the datum axis, and the direction opposite to the first direction is the direction toward the datum axis. When the motor is provided with the reset mechanism, the reset mechanism is configured to pull the rotor back in the direction opposite to the first direction under the low level or the reverse high level of the current vibration signal. When the rotor has not reversed in place, the positive high level of the next vibration signal controls the H-bridge circuit to output the positive current, controlling the rotor to rotate in the first direction again. As shown in FIG. 10, in some embodiments, when the reset mechanism controls the rotor to reverse toward the datum axis, the reverse high level ( having a polarity opposite to the positive high level of the current vibration signal that drives that rotor to rotate away from the datum axis, such as p1n and n1p in FIG. 10) is configured to control the H-bridge circuit to output the reverse current, causing the rotor of the motor to reverse toward the datum axis, so that the rotor reverses toward the datum axis under a dual action of the electric drive and the reset mechanism, thereby increasing the reset force and enhancing the cleaning effect.

In some embodiments, the step of controlling the rotor of the motor to perform the reciprocating vibrations relative to the reference axis based on the drive signal, and changing the position of the reference axis to increase the vibration coverage range of the rotor comprises a step: controlling the rotor to move in the first direction; and controlling the rotor to move in the first direction again to change the position of the reference axis when the reverse motion of the rotor in the direction opposite to the first direction is not in place.

Specifically, in the embodiment, the rotor is controlled to move in the first direction and then controlled to move in the direction opposite to the first direction. The first direction toward either left or right. When the rotor does not reverse to the starting position, the rotor is moved again in the first direction, so that a distance or an angle of a forward motion of the rotor differs from a distance or an angle of a reverse motion of the rotor, thereby changing the position of the reference axis of the rotor. In the rotational vibrations, the position of this reference axis is represented by the angle between the reference axis and the datum axis. The datum axis is the fixed reference axis of the motion of the rotor. The datum axis may be the center axis of the movable range of the rotor or another fixed position. The relative position of the rotor or the relative position of the reference axis is determined based on the datum axis.

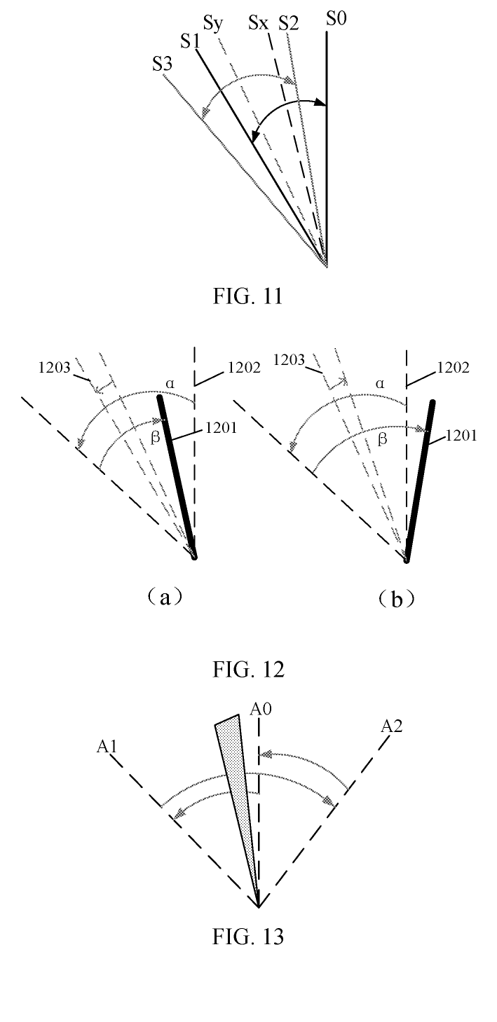

For instance, as shown in FIG. 11, after rotating a certain angle to the left from the starting position S0 to reach a position S1, the moves reverses rightward and returns to the starting position S0. At this time, the reference axis of the rotor is at a position Sx. When the rotor rotates and reverses with the same amplitude, the rotor vibrates back and forth between the position S1 and the position S0, with the reference axis of the rotor remaining unchanged at the position Sx. When the rotor does not reverse to the starting position S0, but rotates to the left again at a certain angle at a position S2 halfway to reach a position S3, the reference axis is deflected to the left at this time. When the rotor vibrates back and forth between the position S2 and the position S3, the reference axis of the rotor is located at the Sy position, and the vibration area of the rotor changes. Under the control of the drive signal, the rotor regularly changes the rotation angle of the reference axis in the manner described, so that the rotor is able to sweep over a large range, thereby enabling the rotor to vibrate with a small amplitude while sweeping over a larger range. It should be noted that the first direction towards left or right, and when the reverse motion of the rotor is not in place, it means that the rotor is reversed to a non-starting position. That is, there may be two situations: a first situation is that the reverse motion of the rotor does not reach the starting position, and a second situation is that the reverse motion of the rotor passes through the starting position.

In some embodiments, the reset mechanism is an elastic reset mechanism. The greater the rotation angle of the reference axis relative to the datum axis, the longer a duration of the high level in each of the vibration signals when controlling the rotor to rotate for a same rotation angle. And/or, the greater the rotation angle of the reference axis relative to the datum axis, the shorter a duration of the reverse high level in each of the vibration signal when controlling the rotor to move for the same rotation angle. When the rotation angle of the reference axis relative to the datum axis is greater than a first predetermined angle, the duration of the reverse high level in each of the vibration signals is zero.

In the embodiment, the reset mechanism is the elastic reset mechanism using an elastic element (such as a spring) to provide a reset force. When the motor is in a working state, the high level of the single vibration signal causes the rotor to rotate away from the datum axis. When the rotor is under the reference level, the elastic element (such as a coil spring or a torsion spring) releases stored elastic energy, generating the reset force that pulls the rotor back toward the datum axis. Due to the characteristics of the elastic element, the greater a deviation angle of the rotor from the datum axis, the more elastic energy the elastic element needs to store, and the stronger the reset force. The smaller the deviation angle of the rotor from the datum axis, the less elastic energy the elastic element needs to store, and the weaker the reset force. Therefore, as the reference axis rotates at a greater rotation angle relative to the datum axis, the greater the force required to maintain uniformity in the amplitude of each of the reciprocating vibrations of the rotor, and the greater the force required to overcome the reset force of the reset mechanism. Consequently, the duration of the high level of the single vibration signal should increase. For example, as shown in FIG. 6, as the rotation angle of the reference axis increases, the duration of high levels of p1-p5 gradually increase, and as the rotation angle of the reference axis reduces, the duration of the high levels of p6-p10 gradually reduce.

In the embodiment, when the deviation angle of the rotor relative to the datum axis is small, each reverse high level is provided to assist the reset mechanism in controlling the rotor to reverse, so as to increase the force of the rotor reversal and improve the cleaning effect. When the deviation angle of the rotor relative to the datum axis is large, the elastic element of the reset mechanism outputs the reset force, and there is no need to control the rotor reversal through each reverse level. For example, as shown in FIG. 10, when the reference axis rotation angle is small, after under the high level p1, the reverse high level p1n controls the rotor to reverse, and after the high level p2, the reverse high level p2n controls the rotor to reverse. When the rotation angle of the reference axis is large, the duration of the reverse high level of the single vibration signal is reduced, and when the rotation angle of the reference axis is greater than the first predetermined angle, the reverse high level of the single vibration signal is reduced to 0. That is, no reverse high level is applied. The duration of the reverse high level of each of the vibration signals is dynamically adjusted according to the rotation angle of the reference axis to ensure that the rotor is able to vibrate stably and evenly, thereby improving the cleaning effect.

In some embodiments, the reset mechanism is a magnetic reset mechanism. The smaller the rotation angle of the reference axis relative to the datum axis, the longer the duration of the high level in each of the vibration signals when controlling the rotor to rotate at the same rotation angle as the reference axis. The smaller the rotation angle of the reference axis relative to the datum axis, the shorter the duration of the reverse high level in each of the vibration signals when controlling the rotor to rotate at the same rotation angle as the reference axis. When the rotation angle of the reference axis relative to the datum axis is less than a second predetermined angle, the duration of the reverse high level in each of the vibration signals is 0.

In the embodiment, the reset mechanism is the magnetic reset mechanism, which uses a magnetic force generated by a permanent magnet or an electromagnet to provide the reset force. When the motor is in the working state, the high level of the single vibration signal causes the rotor to rotate away from the datum axis. When the single vibration signal is at the reference level, a magnetic field generated by the permanent magnet or the electromagnet exerts the reset force, pulling the rotor back toward the datum axis. Due to the characteristics of the permanent magnet or the electromagnet, the reset force exerted by the magnetic field increases as the deviation angle of the rotor from the datum axis decreases; the reset force exerted by the magnetic field reduces as the deviation angle of the rotor increases. Therefore, to maintain the uniformity in the amplitude of each of the reciprocating vibrations of the rotor, the rotor requires a greater rotation force to overcome the reset force of the reset mechanism. Accordingly, the duration of the high level of the single vibration signal should be increased.

In the embodiment, when the deviation angle of the rotor relative to the datum axis is large, the reverse high level of the single vibration signal is provided to assist the reset mechanism in controlling the reverse rotation of the rotor, thereby increasing the force of the reverse rotation and improving the cleaning effect. When the deviation angle of the rotor relative to the datum axis is small, the magnetic force generated by the permanent magnet or the electromagnet in the reset mechanism outputs sufficient reset force, eliminating the need for controlling the reverse rotation of the rotor by the reverse high level of the single vibration signal. The duration of the reverse high level of each of the vibration signals is dynamically adjusted according to the rotation angle of the reference axis to ensure stable and uniform vibrations of the rotor, improving the cleaning effect.

In some embodiments, the high level of each of the vibration signals controls the rotor to move in the first direction, the low level of each of the vibration signals does not drive the rotor to move, and the reverse high level of each of the vibration signals controls the rotor to move in the direction opposite to the first direction.

Specifically, when the motor does not comprise the reset mechanism, the motion of the rotor is controlled solely by the high level of each of the vibration signals. The positive high level and the negative high level of each of the vibration signals control the motion of the rotor in different directions. The low level of each of the vibration signals does not drive the rotor to move.

In some embodiments, each of the sweeping signals is a periodic signal, with the polarity of vibration signals in the first half cycle thereof being opposite to the polarity of the vibration signals in the second half cycle thereof. The first half cycle and the second half cycle of each of the sweeping signals respectively control the reference axis to sweep across the areas on two sides of the datum axis.

Specifically, as shown in FIGS. 6 and 10, each of the sweeping signals is the periodic signal, the polarity of the vibration signals in the first half cycle thereof is opposite to the polarity of the vibration signals in the second half cycle thereof, and the first half cycle and the second half cycle of each of the sweeping signals respectively control the reference axis to across the areas on two sides of the datum axis. The vibration rules of the sweeping motion on two sides of the datum axis maybe the same.

In some embodiments, the first half cycle and the second half cycle of each of the sweeping signals are connected by a transition low level, and a total duration of the transition low level thereof is greater than a predetermined duration, so that the rotor is allowed to be reset to the datum axis.

Specifically, at a junction of the first half cycle and the second half cycle of each of the sweeping signals, the transition low level of each of the sweeping signals is maintained for a long period, so that the rotor is stably reset to the datum axis, ensuring stable control when the rotor switches the sweeping vibration area without deviation.

In some embodiments, the first half cycle and the second half cycle of each of the sweeping signals are connected by a transition reverse high level, and the transition reverse high level thereof makes two ends of the motor short-circuited.

Specifically, in addition to using the transition low level of each of the sweeping signals to allow the rotor to naturally slow down and reset due to the resistance between friction and inertia, a method of controlling the brake of the rotor is able to actively apply a reverse torque to the motor to quickly offset kinetic energy retained on the rotor and quickly stop the motor from rotating. That is, the transition reverse high level of each of the sweeping signals is connected between the first half cycle and the second half cycle of each of the sweeping signals, and the two ends of the motor are short-circuited by the reverse high level. At this time, since the rotor is still moving, a back electromotive force inside the motor generates the current, thereby forming a braking torque to stop the motor. In a high-level braking mode, the back electromotive force generated in the motor generates a braking current through a short circuit, and the reverse torque decelerates the motor, which allows the kinetic energy remaining on the rotor to be quickly offset, thereby achieving rapid braking.

In some embodiments, the control method further comprises controlling the reference axis to rotate relative to the datum axis based on the drive signal. The first direction comprises a rotation direction toward the datum axis or a rotation direction away from the datum axis.

Specifically, the datum axis is the fixed reference axis of the motion of the rotor. The datum axis may be the center axis of the movable range of the rotor or another fixed position. The relative position of the rotor or the relative position of the reference axis is determined based on the datum axis. With the datum axis as a reference system, the rotation direction of the rotor and a rotation method of the reference axis are re-divided into the rotation direction toward the datum axis or the rotation direction away from the datum axis.

In some embodiments, the step of controlling the reference axis to rotate relative to the datum axis based on the drive signal comprises: controlling, based on the drive signal, a rotation angle of the rotor toward the datum axis to be greater than a rotation angle of the rotor away from the datum axis when the rotor is controlled to vibrate, so that the reference axis rotates toward the datum axis; and/or controlling the rotation angle of the rotor away from the datum axis to be greater than the rotation angle of the rotor toward the datum axis when the rotor is controlled to vibrate, so that the reference axis rotates away from the datum axis.

In some embodiments, when the vibration signals satisfy a first condition, the rotation angle of the rotor away from the datum axis when the rotor vibrates at a high level of the vibration signals is greater than the rotation angle of the rotor towards the datum axis when the rotor vibrates at a low level and/or a reverse high level in the vibration signals; and/or when the vibration signal satisfies a second condition, the rotation angle of the rotor at the high level in the vibration signals away from the datum axis when the rotor is vibrating is less than the rotation angle of the rotor when the rotor vibrates towards the datum axis when the rotor vibrates, so that the reference axis rotates toward the datum axis.

Specifically, as shown in image (a) in FIG. 12, during the single reciprocating vibration, the rotor 1201 may first rotate from the starting position 1202 away from the datum axis (left side in FIG. 12) and then reverse toward the datum axis. When the duration of the high level in the single vibration signal meets the first condition (e.g., the duration of the high level thereof is greater than the duration of the low level thereof), the rotation angle of the rotor 1201 away from the datum axis is greater than the rotation angle of the rotor 1201 toward the datum axis (α>β), indicating that rotor 1201 is not reversed in place. As a result, a rotation centerline 1203 of the rotor 1201 shifts away from the datum axis. Under the rotational rule, as the rotor vibrates, the reference axis thereof gradually rotates away from the datum axis, forming the sweeping vibration. As shown in image (b) of FIG. 12, when the duration of the high level in the single vibration signal meets the second condition (e.g., the duration of the high level thereof is shorter than the duration of the low level thereof), the rotation angle of the rotor 1201 toward the datum axis during the single reciprocating vibration is greater than the rotation angle of the single reciprocating vibration away from the datum axis (β>α), indicating that the rotor 1201 is not reversed in place (over-reversed), and the rotation centerline 1203 of rotor 1201 shifts toward the datum axis. Under the rotation rule, as the rotor vibrates, the reference axis gradually rotates toward the datum axis, forming the sweeping vibration.

For example, during the single reciprocating vibration, the rotor may first rotate toward the datum axis and then reverse away from the datum axis. When the rotation angle of the rotor toward the datum axis is greater than the rotation angle of the rotor away from the datum axis, or when the duration of the high level in the single vibration signal satisfies the second condition, such as the duration of the high level of the single vibration signal is less than the duration of the low level (in this case, the rotation angle of the rotor toward the datum axis during vibration is greater than the rotation angle of the rotor away from the datum axis), then the rotor is not reversed in place, and the reference axis of the rotor shifts toward the datum axis. Under the rotation rule, as the rotor vibrates during the reciprocating vibrations, the reference axis gradually rotates toward the datum axis, forming the sweeping vibration. When the rotation angle of the rotor away from the datum axis is greater than the rotation angle of the rotor toward the datum axis, or when the duration of the high level of the single vibration signal satisfies the first condition, such as the duration of the high level of the single vibration signal is greater than the duration of the low level thereof (in this case, the rotation angle of the rotor away from the datum axis during the single reciprocating vibration is greater than the rotation angle of the rotor toward the datum axis), then the rotor is not reversed in place (over-reversed), and the reference axis of the rotor rotates away from the datum axis. Under the rotation rule, as the rotor vibrates during the reciprocating vibrations, the reference axis gradually rotates away from the datum axis, forming the sweeping vibration.

Based on the drive signal (e.g., the duration of the high levels in the vibration signals), the rotor rotates, and the reference axis rotates toward or away from the datum axis while vibrating according to various rotation rules. The wide sweep of the reference axis allows the rotor to achieve a wide sweep while maintaining a small amplitude, significantly increasing the vibration coverage range of the rotor and covering more tooth surfaces.

In some embodiments, each of the vibration signals of the sweeping signals sequentially satisfies the first condition before satisfying the second condition.

Specifically, during a cleaning process, under the control of the sweeping signals, the rotation angle of the reference axis of the motor relative to the datum axis may gradually increase or decrease as the number of the reciprocating vibrations increases, thereby achieving a regular change in the position of the reference axis. Specifically, the motor gradually sweeps left or right while maintaining the reciprocating vibrations, increasing the vibration coverage range and improving cleaning effectiveness.

The vibration signals of the sweeping signals first meet the first condition: controlling the motor to vibrate with the rotation angle away from the datum axis being greater than the rotation angle toward the datum axis, so that the reference axis rotates away from the datum axis, and the rotation angle of the reference axis relative to the datum axis gradually increases during the reciprocating vibrations. When the rotation angle of the reference axis relative to the datum axis reaches a third predetermined angle, the vibration signals of the sweeping signals then meet the second condition: controlling the motor to vibrate with the rotation angle away from the datum axis being less than the rotation angle toward the datum axis, so that the reference axis rotates toward the datum axis, and the rotation angle of the reference axis relative to the datum axis gradually decreases during the reciprocating vibrations. In this way, the reciprocating sweeping motion of the rotor is formed, which achieves a second cleansing of previously cleaned tooth surfaces and improves cleaning effectiveness.

In some embodiments, the step of controlling the rotor of the motor to perform the reciprocating vibrations relative to the reference axis based on the drive signal comprises: controlling, based on the drive signal, the rotor to reciprocate linearly or rotationally relative to the reference axis, so that the rotor vibrates; and/or controlling, based on the drive signal, the rotor to move away from the datum axis, and driving, by the reset mechanism, the rotor to move toward the datum axis, so that the rotor vibrates. The motor comprises the reset mechanism, and the reset mechanism is capable of resetting toward the datum axis.

Specifically, the motor is selected from the motor with the reset mechanism and the motor without the reset mechanism. For the motor without the reset mechanism, the oral care device is able to control the H-bridge circuit to output positive and negative currents based on the drive signal, thereby controlling the rotor to achieve the reciprocating vibrations. For instance, each positive level of the drive signal controls the H-bridge circuit to output the positive current, causing the motor to move in the first direction. Each negative level of the drive signal controls the H-bridge circuit to output the negative current, causing the rotor to move in the direction opposite to the first direction. Under the control of the drive signal, the H-bridge circuit continuously outputs the positive and negative currents, causing the rotor to move toward and away from the datum axis, thereby generating the reciprocating vibrations. For instance, within a vibration circle T, the drive signal alternates between each positive level and a corresponding negative level, achieving the reciprocating vibrations of the rotor.

The motor with the reset mechanism is able to drive the rotor of the rotor to reset toward the datum axis. An exemplary waveform diagram of the drive signal is shown in FIG. 6. During the vibration cycle T2, the drive signal controls the H-bridge circuit to output the positive current or the negative current through each high level thereof (positive high level or negative high level), causing the rotor of the motor to move away from the datum axis. The positive current is configured to control the rotor to move in the first direction away from the datum axis, while the negative current is configured to control the rotor to move in the direction opposite to the first direction. When the drive signal is at the low level of any one of the vibration signals (the reference level), the reset mechanism drives the rotor to rotate toward the datum axis.

The reset mechanism is selected from the elastic reset mechanism or the magnetic reset mechanism. The elastic reset mechanism uses the elastic element (such as the spring) to provide the reset force. When the motor is in the working state, the high level of the current vibration signal (positive or negative) of the drive signal causes the rotor to move away from the datum axis. When the drive signal is at the low level of the current vibration signal (reference level), the elastic element (such as the coil spring or the torsion spring) releases the stored elastic energy, generating the reset force that pulls the rotor back toward the datum axis. The magnetic reset mechanism uses the magnetic force generated by the permanent magnet or the electromagnet to provide the reset force. When the motor is in the working state, the positive level or the negative level of the current vibration signal of the drive signal causes the rotor to move away from the datum axis. When the drive signal is at the low level of the current vibration signal (reference level), the magnetic field generated by the permanent magnet or the electromagnet exerts the reset force that pulls the rotor back toward the datum axis.

It should be noted that when the motor comprises the reset mechanism, the oral care device further controls the H-bridge circuit to output a reverse current based on the reverse level of the current vibration signal of the drive signal when the rotor is away from the datum axis, causing the motor to move in the opposite direction toward the datum axis. Under the dual action of the electric drive and the reset mechanism, the drive signal pulls the rotor back toward the datum axis, which increases the reset force of the rotor of the motor, thereby increasing the vibration force of the motor and improving the cleaning effect. For instance, a waveform diagram of the drive signal is shown in FIG. 10. Within the vibration cycle T2, the drive signal controls the H-bridge circuit to output the positive current or the negative current through the positive level or the negative level of each of the vibration signals, causing the rotor of the motor to move away from the datum axis. Further, under each reference level, the rotor moves toward the datum axis based on the reset force of the reset mechanism. Furthermore, the drive signal controls the H-bridge circuit to output the reverse current through the reverse high level of each of the vibration signals, causing the rotor to move toward the datum axis, so that the rotor moves in the direction opposite to the datum axis under the dual action of the electric drive and the reset mechanism.

In some embodiments, the control method further comprises a step: controlling, based on the drive signal, the rotor to vibrate relative to the reference axis at a predetermined amplitude, and controlling the reference axis to move to change a vibration center of the rotor, where the predetermined vibration amplitude of the rotor is less than the motion range of the reference axis; or gradually increasing a vibration amplitude of the rotor based on the drive signal, and changing the position of the reference axis; or gradually reducing the vibration amplitude of the rotor based on the drive signal, and changing the position of the reference axis.

Specifically, under the control of the drive signal, the rotor rotates back and forth at a consistent predetermined amplitude, while simultaneously controlling the reference axis to rotate to shift the vibration center, which allows the rotor to achieve a wide sweeping motion while maintaining the same vibration amplitude. Optionally, the predetermined vibration amplitude of the rotor is less than the motion range of the reference axis, which means that the motor performs the reciprocating vibrations with a small swing amplitude and performs the sweeping motion with a large swing amplitude. Thus, the tooth sensitivity of the user is considered while increasing the cleaning range and cleaning intensity.

Optionally, under the control of the sweeping signals, the duration of the high levels of the vibration signals of each of the sweeping signals gradually increases or decreases; and/or the duration of the low levels of the vibration signals of each of the sweeping signals gradually increases or decreases; and/or the duration of the reverse high levels of the vibration signals of each of the sweeping signals gradually increases or decreases. The rotor is allowed to perform the reciprocating vibrations according to different vibration amplitudes, such as controlling the vibration amplitude of the rotor to gradually increase or decrease, while changing the position of the reference axis and the position of the vibration center to achieve regular vibrations (the reciprocating vibrations) and sweeping vibrations. It provides richer vibration modes to adapt to different usage needs and scenarios, while ensuring the cleaning effect and improving the comfort of the user during use.

In some embodiments, the control method further comprises steps: controlling, based on the drive signal, the rotation angle of the rotor away from the datum axis to be equal to the rotation angle of the rotor towards the datum axis during each of the reciprocating vibrations of the rotor, so that the rotor resets to the position of the datum axis after vibrating after each of the reciprocating vibrations; and/or controlling, based on the drive signal, the rotation angle of the rotor away from the datum axis in the reciprocating vibrations of the rotor to be equal to the rotation angle of the rotor towards the datum axis, and keeping the rotation angle of the rotor being unchanged, so that the rotor continuously vibrates relative to the reference axis at an equal angle when the reference axis remains unchanged. For example, but not limited to, the sweeping signals are configured to control the rotation angle of the motor to rotate away from the datum axis during each of the reciprocating vibrations to be equal to the rotation angle of the motor toward the datum axis. Alternatively, the sweeping signals are configured to control the rotation angle of the motor to rotate away from the datum axis during the reciprocating vibrations to be equal to the rotation angle of the motor toward the datum axis.

Specifically, under the control of the drive signal or the sweeping signals, the motor is able to reverse to the starting position after each of the reciprocating vibrations. Generally, the starting position of the motor is set to be the position of the datum axis. In this case, after reach of the reciprocating vibrations, the motor resets to the datum axis. The reference axis is rotated by changing the vibration amplitudes of the reciprocating vibration, thereby changing the position of the vibration center and shifting the position of the reference axis.

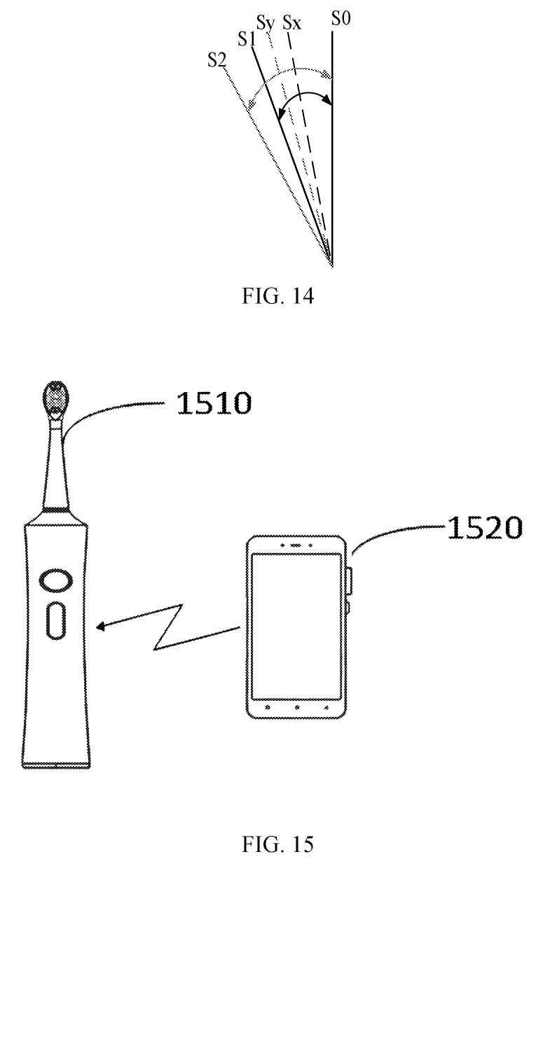

For instance, as shown in FIG. 14, the rotor rotates leftward by a first angle from the starting position S0 to the position S1, then the rotor reverses rightward and returns to the starting position S0. At this time, the reference axis of the rotor is at the position Sx. Then, the motor changes the vibration amplitude (for example, increasing the vibration amplitude), and rotates leftward by a second angle from the starting position S0 to the position S2. At this time, the reference axis of the rotor is at the position Sy. Furthermore, the rotor is also allowed to symmetrically rotate to the right, or reduce the vibration amplitude, in accordance with the aforementioned rotational pattern. Under the control of the drive signal, the rotor regularly changes the rotation angle of the reference axis, enabling the rotor to sweep across a wide range by changing the vibration amplitude, providing a flexible and powerful cleaning effect.

In addition, the rotor is capable of maintaining the same reciprocating vibrations for a certain duration or number of times while performing the sweeping motion during the cleaning process. That is, some of the vibration signals within each of the sweeping signals are the same and are continuous It is understandable that during the cleaning process, some of the vibration signals are the same and are continuous, so that the vibration process of the rotor comprises both a vibration mode that changes the position of the reference axis and a vibration mode that the continuous reciprocating vibrations do not change the position of the reference axis, and both a vibration mode that changes the vibration amplitude and a vibration mode that does not change the vibration amplitude during multiple reciprocating vibrations. In this case, during the single reciprocating vibration of the rotor, when the rotation angle of the rotor away from the datum axis is equal to the rotation angle of the rotor toward the datum axis, and when the rotation angle remains unchanged, the starting position and the reverse stop position of the rotor are the same, and the position of the reference axis of the rotor does not change. When the single reciprocating vibration is performed multiple times in succession, the rotor achieves continuous vibrations with the same vibration amplitude and the same position of the reference axis position. For instance, during the cleaning process, the rotor performs the reciprocating vibrations having the same vibration amplitude within a range of 5-10° relative to the datum axis, and then changes the position of the reference axis, so that the rotor then performs reciprocating vibrations having the same vibration amplitude within a range of 7-12° relative to the datum axis. By setting the reciprocating vibrations having the same vibration amplitude during the sweeping motion of the rotor, a sweeping speed of the motor is flexibly controlled. At the same time, the cleaning force on the same position of the teeth is enhanced, avoiding a situation where the rotor changes the position of the reference axis and drives the brush head to rotate to other positions before one position is cleaned thoroughly.

In some embodiments, the control method further comprises a step: gradually increasing, based on the drive signal, a distance or the rotation angle of the reference axis relative to the datum axis as the vibration times of the rotor increase; or gradually reducing, based on the drive signal, the distance or the rotation angle of the reference axis relative to the datum axis as the vibration times of the rotor increase.

Specifically, the distance or the rotation angle of the reference axis relative to the datum axis is set to represent the relative position of the reference axis. During the cleaning process, under the control of the drive signal, the distance or the rotation angle of the reference axis of the rotor relative to the datum axis gradually increases or decreases as the number of the reciprocating vibrations increases, thereby achieving a regular change in the position of the reference axis. That is, the rotor gradually sweeps to the left or right while maintaining the reciprocating vibrations, thereby increasing the vibration coverage range and improving the cleaning effect.

In some embodiments, the control method further comprises a step: gradually increasing, based on the drive signal, the distance or the rotation angle of the reference axis relative to the datum axis to a first predetermined angle and then gradually reducing the distance or the rotation angle of the reference axis relative to the datum axis, as the vibration times of the rotor gradually increase, thereby forming a reciprocating sweeping motion of the rotor, so that the cleaned tooth surfaces are cleaned again to improve the cleaning effect.

In some embodiments, the control method further comprises a step: as the vibration times of the rotor gradually increase, gradually increasing, based on the drive signal, the rotation angle of the reference axis relative to the datum axis to a second predetermined angle in the first direction, then gradually reducing the rotation angle of the reference axis relative to the datum axis in the first direction, then gradually increasing the rotation angle of the reference axis relative to the datum axis to a third predetermined angle in the direction opposite to the first direction, and gradually reducing the rotation angle of the reference axis relative to the datum axis in the direction opposite to the first direction. The first direction may be any direction to the left or right relative to the datum axis.

In some embodiments, each of the sweeping signals is a periodic signal, and the polarity of the vibration signals in the first half cycle of each of the sweeping signals is opposite to the polarity of the vibration signals in the second half cycle of each of the sweeping signals. In the first half cycle, the vibration signals in each of the sweeping signals satisfy the first condition in sequence and then satisfy the second condition. In the second half cycle, the vibration signals in each of the sweeping signals satisfy the first condition in sequence and then satisfy the second condition.

Specifically, the rotor maintains a vibrating state. The rotor first sweeps back and forth toward a first side of the datum axis, then sweeps toward a second side of the datum axis, creating a periodic sweeping motion of the rotor. The vibration trajectory of the rotor is not concentrated on a single side of the datum axis, but rather covers a wide area on two sides of the datum axis, which allows a vibration trajectory of the oral care device to cover a larger area of teeth and gums, so that the teeth are fully cleaned. The periodic sweeping motion of the rotor allows the brush head to perform vibratory cleaning on the same area. The periodic sweeping motion of the brush head across the teeth aligns with the Bass method of brushing, helping to remove stubborn plaque and food debris. Furthermore, the automated periodic sweeping motion reduces the need for manual brushing, making the brushing process simpler and more efficient.

For instance, as shown in FIG. 13, under the control of the sweeping signals, the rotor maintains the reciprocating vibrations with a certain predetermined vibration amplitude, and as the number of the reciprocating vibrations increases, the rotation angle of the reference axis is controlled to gradually increase to the position A1 and gradually decrease to the position A0 of the datum axis, then the rotation angle of the vibration reference axis is controlled to gradually increase to the position A2 and gradually decrease to the position A0 of the datum axis, hereby forming a periodic sweeping vibration effect.

In some embodiments, the control method further comprises: controlling the rotor to rotate toward the datum axis and/or away from the datum axis at the same angle during the reciprocating vibrations based on the drive signal.

Specifically, the rotor maintains the rotation angle toward the datum axis being the same as the rotation angle away from the datum axis during each of the reciprocating vibrations. For example, the rotor may rotate 10 degrees toward the datum axis or 10 degrees away from the datum axis during each of the reciprocating vibrations. When the rotation angle of the rotor toward the datum axis is the same as the rotation angle of the rotor away from the datum axis, the rotor sweeps the reference axis at a fixed sweeping speed.

In some embodiments, the control method further comprises: controlling the rotation angle of the reference axis to change at a constant angle relative to the datum axis based on the drive signal.

Specifically, when the reference axis changes at a constant angle relative to the datum axis, whether to rotate to the left or right, the rotation angle of the reference axis remains constant during each of the reciprocating motions. For instance, each time the position of the reference axis changes, whether clockwise or counterclockwise, the reference axis rotates a fixed 5 degrees.

Through the regular vibration mode, the rotor drives the brush head to maintain a uniform motion trajectory during oral cleaning, which enables the brush head to cover all areas of the tooth surfaces and gums, avoids blind spots, and ensures that the teeth are fully cleaned. The regular changes in the reference axis further improves user comfort.

In some embodiments, when the rotor is controlled to perform the reciprocating vibrations having different vibration amplitudes based on the drive signal, the vibration frequencies of the reciprocating vibrations are the same, or the vibration frequencies of the vibration signals of each of the sweeping signals are the same.

In some embodiments, the control method further comprises: when the rotor is controlled to perform the reciprocating vibrations having different vibration amplitudes based on the drive signal, controlling the vibration frequencies of the reciprocating vibrations being the same. Specifically, different vibration amplitudes of the reciprocating vibrations of the rotor mean that the rotor may vibrate at different amplitudes, and the vibration frequency of the vibration signals refers to the number of times the rotor completes a vibration cycle per second. Each of the sweeping signals is a composite signal composed of the vibration signals and is configured to control the vibration mode and the sweeping mode of the rotor. In the embodiment, the frequencies of the vibration signals remains unchanged, meaning that regardless of changes in the vibration amplitude of the rotor, the vibration frequency of the rotor remains constant throughout the sweeping process. For example, when the vibration amplitude of the rotor changes from 5 degrees to 10 degrees, the vibration frequency remains at a predetermined frequency, such as 30 reciprocating vibrations per second (30 Hz). The consistent vibration frequency of the rotor ensures consistent strength and effectiveness of each of the reciprocating vibrations, ensuring that cleaning results are not affected by changes in the vibration amplitude of the rotor, and providing stable and effective cleaning power regardless of changes in the vibration amplitude of the rotor. The consistent vibration frequency of the rotor avoids discomfort caused by frequency change, thereby providing a smoother and more comfortable vibration experience for the user.

In some embodiments, the duration of the high levels of the vibration signals is the same, the duration of the low levels of the vibration signals is the same, or the duration of the reverse high levels of the vibration signals is the same.

In some embodiments, the control method further comprises controlling, based on the drive signal, the rotor to rotate at the same angle toward the datum axis and/or the same angle away from the datum axis during each of the reciprocating vibrations.

Specifically, the rotor maintains a consistent rotation angle toward the datum axis and/or away from the datum axis during each of the reciprocating vibrations. For example, the rotor may rotate 10 degrees toward the datum axis or 10 degrees away from the datum axis during each of the reciprocating vibrations. When the rotation angle of the rotor toward the datum axis and the rotation angle of the rotor away from the datum axis remain constant, the rotor sweeps the vibration reference axis at a fixed sweeping frequency. In some embodiments, by setting at least one of the duration of the high level and the duration of the low levels in each of the sweeping signals to be the same, regular sweeping motion is achieved, thereby improving user comfort.

In some embodiments, the control method further comprises when controlling the rotor to perform the reciprocating vibrations having different vibration amplitudes based on the drive signal, controlling the vibration frequencies being different. The greater the vibration amplitude of the reciprocating vibrations of the rotor, the lower the vibration frequency.

Optionally, when the rotor vibrates at different vibration amplitudes, different vibration amplitudes correspond to different vibration frequencies of the vibration signals. Specifically, the lower the vibration frequency of the single vibration signal, the greater the vibration amplitude of the rotor.

Specifically, the vibration frequencies are adjusted based on different vibration amplitudes. The drive signal that is predetermined. The lower the vibration frequency of the single vibration signal, the greater the vibration amplitude of the rotor controlled by the drive signal, and greater the vibration frequency of the single vibration signal, the lower the vibration amplitude of the rotor controlled by the drive signal. Alternatively, the vibration frequency of the single vibration signal is adjusted based on a corresponding vibration amplitude. A greater vibration amplitude of the rotor corresponds to a lower vibration frequency of the vibration signal, while a smaller vibration amplitude of the rotor corresponds to a greater vibration frequency of the single vibration signal. For example, when the vibration amplitude is 10 degrees, the vibration frequency or the frequency of the single vibration signal is 20 Hz. When the vibration amplitude is 5 degrees, the vibration frequency or the frequency of the single vibration signal is 40 Hz. A larger vibration amplitude of the rotor provides a wider vibration coverage range, thereby facilitating cleaning of a larger area of the teeth, while a lower frequency of the single vibration signal provides a lower vibration frequency, thereby reducing irritation to the teeth and gums.

In some embodiments, the motor comprises a limiter configured to limit a maximum motion range of the rotor.

Specifically, the limiter is a mechanical or an electronic component mounted on the motor, the limiter is configured to limit a maximum rotation angle of the rotor, and the limiter is configured to ensure that the rotor moves within a predetermined range. The limiter may be mechanical stops, a spring mechanism, or an electronic sensor, which physically or electronically limits the maximum rotation angle of the rotor. For example, the limiter is configured to limit the maximum rotation angle of the rotor to 15 degrees.

The limiter effectively prevents excessive motion of the rotor beyond the predetermined range, avoids damage to the motor and related components, and improves the safety and reliability of the motor. By limiting the rotation angle of the rotor, the limiter reduces wear and fatigue of the motor caused by excessive motion, thereby extending the lifespan of the motor. By limiting the maximum rotation angle of the rotor, it further ensures that the motor of the oral care device operates within a stable vibration range, resulting in more uniform and effective cleaning. A motion range of the reference axis is less than the maximum motion range of the rotor.

In some embodiments, the rotor resets to the same predetermined datum axis during the reciprocating vibrations. The datum axis serves as a fixed reference axis for the motion of the rotor.

Specifically, the rotor has the fixed reference axis. In the initial state of the rotor, the rotor is located at the datum axis. When the motor is in the stopped state, the rotor should also be located at the datum axis. During each of the reciprocating vibrations, the rotor rotates away from the datum axis and then resets toward the datum axis (not necessarily to reset in place). By providing a fixed reference axis, it ensures the stability of the motion of the rotor and allows for stable switching of the sweeping direction of the rotor. Therefore, the reciprocating vibrations of the rotor covers a wide area on two sides of the datum axis, which allows the vibration trajectory of the oral care device to cover a larger area of the teeth and gums, preventing missed areas.

In some embodiments, the drive signal comprises the sweeping signals, and each of the sweeping signals comprises the vibration signals. The control method further comprises controlling the rotor to vibrate based on the vibration signals; and controlling the rotor to vibrate based on the sweeping signals, and changing the position of the reference axis to form the sweeping motion of the rotor.

Specifically, the vibration signals are the basic signals that drive the rotor by controlling each of the vibration signals, the rotor is controlled to perform a single reciprocating vibration. The sweeping signals, each composed of the vibration signals, control an overall motion mode of the rotor. By combining different vibration signals and changing the position of the reference axis, the sweeping effect is achieved. The motor is controlled based on the sweeping signals, causing the rotor to not only perform small-amplitude periodic vibrations but also perform large-scale sweeping vibrations as the position of the reference axis changes.

For example, as shown in FIGS. 6 or 10, T1 represents a cycle of a single sweeping signal, and T2 represents a cycle of a single vibration signal. The circle T1, are composed of the vibration signals each of the circle T2. By permuting and combining different vibration signals, regular vibration and sweeping of the rotor are achieved.

In some embodiments, the control method further comprises: controlling the vibration frequency of the rotor based on the frequency of each of the vibration signals; and/or controlling the vibration amplitude of the rotor based on the duty ratio of each of the vibration signals; and/or controlling the sweeping amplitude of the reference axis based on the duration of the high level and/or the duty ratio of each of the vibration signals within each of the weeping signals; and/or controlling the sweeping speed (sweeping frequency) of the reference axis based on the duration of the high levels and/or the duty ratio and/or the frequency corresponding to each of the vibration signals within each of the sweeping signals.

Specifically, the vibration frequency refers to the number of vibration cycles completed by the rotor per second. During a single reciprocating vibration process, the vibration frequency represents the vibration speed of the rotor and is controlled by the frequency of each of the vibration signals. The duty ratio refers to a ratio of the duration of the high level of the single vibration signal within the circle to the total circle. The vibration amplitude of the rotor is controlled by adjusting the duty ratio of each of the vibration signals. A larger duty ratio results in a larger vibration amplitude. The sweeping amplitude and sweeping speed respectively refer to the amplitude and speed of the offset of the reference axis during the sweeping process. The sweeping amplitude needs to be adjusted by the duration of the high level and/or the duty ratio of each of the vibration signals in each of the sweeping signals. The sweeping speed needs to be adjusted by the duration of the high level and/or the duty ratio and/or the frequency of each of the vibration signals in each of the sweeping signals. For instance, the rotor rotates in the first direction, and when the rotor is not reversed relative to the first direction, the rotor is controlled to rotate in the first direction again. By adjusting the duty ratio of the each of vibration signals, the vibration amplitude of the rotor is controlled. By adjusting the vibration frequency of each of the vibration signals, the vibration frequency of the rotor is controlled. By adjusting each of the vibration signals (the duration of the high level and/or the duty ratio and/or the vibration frequency) in each of the sweeping signals, the sweeping amplitude and sweeping speed (the sweeping frequency) of the reference axis are controlled within the sweeping circle.

In some embodiments, the control method further comprises controlling the rotor to rotate in the first direction based on the high level of each of the vibration signals in each of the sweeping signals, and controlling the rotor to rotate in the direction opposite to the first direction based on the low level or the reverse high level of each of the vibration signals. Each of the sweeping signals is the periodic signal. The polarity of the vibration signals in the first half cycle of each of the sweeping signals is opposite to a polarity of the vibration signals in a second half cycle of each of the sweeping signals. The first half cycle and the second half cycle of each of the sweeping signals respectively control the reference axis to sweep on two sides of the datum axis.

Specifically, the first direction is the direction away from the datum axis or the direction toward the datum axis. The high level (positive high level and negative high level) signal is configured to control the H-bridge circuit to output a positive current or a reverse current, so as to drive the rotor to rotate away from the datum axis. When the level of the single vibration signal is low, the oral care device equipped with the reset mechanism uses the reset force of the reset mechanism to drive the rotor to rotate toward the datum axis, creating a vibration effect (the waveform of the drive signal is shown in FIG. 6 as an example). Alternatively, the reverse high level of each of the vibration signals is configured to control the H-bridge circuit to output the reverse current, driving the rotor to rotate toward the datum axis, thereby creating the vibration effect (the waveform of the drive signal is shown in FIG. 10 as an example).

As shown in FIGS. 6 and 10, each of the sweeping signal is the periodic signal. The polarity of the vibration signals in the first half cycle of each of the sweeping signals is opposite to the polarity of the vibration signals in the second half cycle of each of the vibration signals. The first half cycle and the second half cycle of each of the sweeping signals respectively control the reference axis to sweep on two sides of the datum axis. The vibration rules of each of the sweeping singles on the two sides may be the same.

In some embodiments, the first half cycle and the second half cycle of each of the sweeping signals are connected at a transition low level, and a total duration of the transition low level of each of the sweeping signals is greater than a predetermined duration, so that the rotor is allowed to reset to the datum axis.

Specifically, at the connection of the first half cycle and the second half cycle of each of the sweeping signals, the transition low level is maintained for a long enough time so that the rotor is stably reset to the datum axis, ensuring stable control when the rotor switches the sweeping vibration area without deviation.

In some embodiments, the rotor is controlled in an open-loop manner based on the drive signal. The waveform of the drive signal is one or more of the sine wave, the square wave, and the triangular wave to achieve different vibration modes and cleaning effects. Optionally, the drive signal is an electrical signal (e.g., a two-phase signal) to improve stability and reliability of the oral care device, so as to ensure consistent and efficient cleaning results and provide a good user experience.

Next, an oral care device provided by one embodiment of the present disclosure is described with reference to FIG. 1. The oral care device comprises a motor, and the oral care device controls the motion of the motor by the control method described in the above embodiments.

In this way, the rotor is controlled to drive a brush head of the oral care device to vibrate back and forth with a small vibration amplitude, thereby reducing irritation to sensitive teeth. Moreover, by changing the position of the reference axis, the vibration coverage range of the rotor is significantly increased, allowing the brush head to cover more tooth surfaces and reducing a frequency with which the user needs to manually move the oral care device. Therefore, when the user brushes his/her teeth, the brush head fully covers the tooth surfaces, ensuring an efficient oral cleaning effect.

In some embodiments, the oral care device implements open loop control of the motor based on the drive signal.

Specifically, the open-loop control refers to an open-loop control system controlling the operation of the motor without feedback. The motor operates according to the drive signal that is predetermined without adjusting to real-time operating conditions. The open-loop control system is simple to design and low-cost, eliminating the need for complex sensors and feedback control systems, thereby improving system reliability and reducing potential points of failure.

In some embodiments, the oral care device has multiple gears or modes, each of the gears or modes corresponding to different drive signals of different parameters. The parameters of the drive signal comprise at least one of a vibration frequency, a vibration amplitude, a sweeping amplitude, and a sweeping speed.

Specifically, the oral care device is configured to have different operating gears or modes, each of the gears or modes corresponding to a corresponding drive signal. Different gears or modes correspond to different vibration frequencies, vibration amplitudes, sweeping amplitudes, and sweeping speeds to accommodate different cleaning needs. For example, the oral care device provides different cleaning mode options, such as a daily cleaning mode, a sensitive cleaning mode, and a deep cleaning mode. When the user selects the sensitive cleaning mode, the sensitive cleaning mode has a predetermined vibration frequency of 20 Hz, a predetermined vibration amplitude of 5 degrees, a predetermined sweeping amplitude of 10 degrees, and a predetermined sweeping speed of 1 degree/second. The oral care device then inputs the drive signal corresponding to these parameters into the motor for control.

In some embodiments, as shown in FIG. 15, the oral care device 1510 is communicated with a terminal 1520. An application on the terminal 1520 is configured to set one or more of the vibration frequency, vibration amplitude, sweeping angle, and sweeping frequency of the rotor and output a corresponding drive signal to the oral care device 1510.

Specifically, the terminal 1520 comprises, but is not limited to, a smartphone, a tablet, a wearable device, a personal computer, etc. The terminal 1520 and the oral care device 1510 are connected via wired or wireless communication, such as BLUETOOTH, WIFI, or a cellular network. The user is able to set operating parameters of the oral care device 1510, such as one or more of the vibration frequency, the vibration amplitude, the sweeping angle, and the sweeping frequency of the rotor, through the application on the terminal 1520. The application generates the drive signal accordingly and sends the drive signal to the oral care device 1510. The oral care device 1510 then controls the motor based on the drive signal received from the terminal 1520. The user is allowed to easily set the operating parameters of the oral care device through the terminal, so that a precise adjustment of the oral care device is achieved to provide a good user experience, and an optimal cleaning result is obtained.

In some embodiments, the oral care device obtains current oral care information, determines the vibration frequency, vibration amplitude, sweeping angle and sweeping frequency of the rotor based on the current oral care information, and determines the drive signal.

Specifically, the oral care device is configured to determine the current oral care information through a built-in sensor or oral health and care needs input by the user. Based on the current oral care information, the oral care device automatically recommends configuration parameters, such as a vibration frequency, a vibration amplitude, a sweeping angle, and a sweeping frequency of the rotor, and generates the drive signal. The oral care device is allowed to automatically adjust a cleaning mode based on actual oral conditions, providing more personalized and effective cleaning, reducing the need for manual adjustments, and improving the user experience.

The oral care device may be trained by a machine-learning algorithm based on historical cleaning records of the user or relevant big data, thereby improving the comfort and adaptability of the configuration parameters that are automatically recommended.

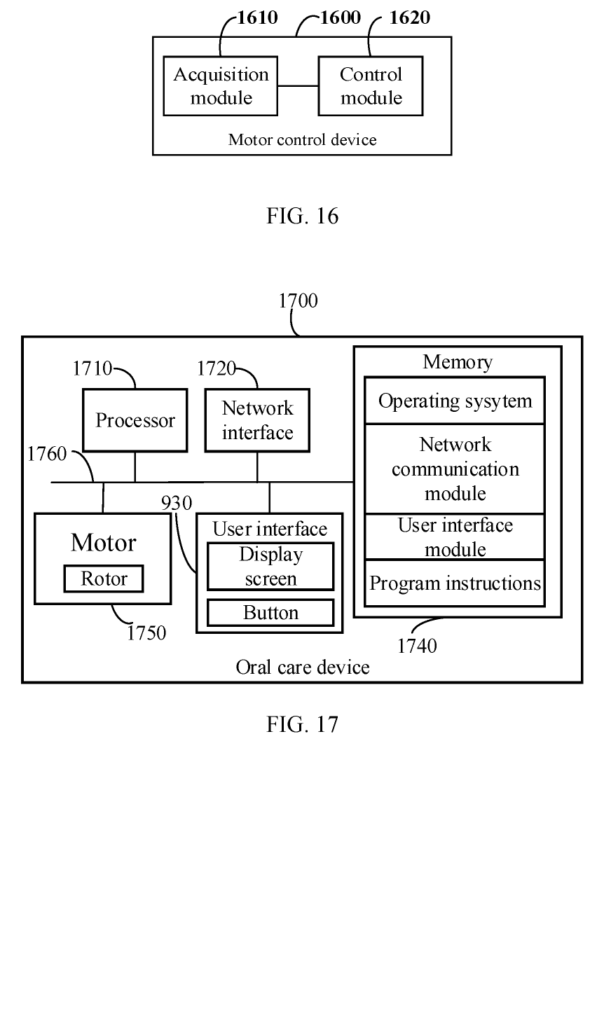

FIG. 16 is a block schematic diagram of a motor control device according to one embodiment of the present disclosure. As shown in FIG. 16, the oral care device comprises a motor, and the motor comprises a rotor. The motor control device 1600 comprises an acquisition module 1610 and a control module 1620. The acquisition module 1610 is configured to obtain a drive signal.

The control module 1620 is configured to control the rotor of the motor to perform the reciprocating vibrations relative to a reference axis based on the drive signal, and change the position of the reference axis to increase the vibration coverage range of the rotor. The reciprocating vibrations comprise linear vibrations or rotational vibrations. The drive signal comprises sweeping signals, and each of the sweeping signals comprises vibration signals. The drive signal is predetermined.

In one optional embodiment, the step of controlling the rotor of the motor to perform the reciprocating vibrations relative to the reference axis based on the drive signal, and changing the position of the reference axis to increase the vibration coverage range of the rotor comprises: controlling the rotor to move in a first direction; and controlling the rotor to move in the first direction again to change the position of the reference axis when a reverse motion of the rotor in a direction opposite to the first direction is not in place.

In one optional embodiment, the control module 1620 is specifically configured to control the reference axis to rotate relative to a datum axis based on the drive signal. The datum axis is a fixed reference axis of motion of the rotor, and the first direction comprises a rotation direction toward the datum axis or a rotation direction away from the datum axis.

In one optional embodiment, the control module 1620 is specifically configured to control, based on the drive signal, a rotation angle of the rotor toward the datum axis to be greater than a rotation angle of the rotor away from the datum axis when the rotor is controlled to vibrate, so that the reference axis rotates toward the datum axis; and/or the control module 1620 is specifically configured to control the rotation angle of the rotor away from the datum axis to be greater than the rotation angle of the rotor toward the datum axis when the rotor is controlled to vibrate, so that the reference axis rotates away from the datum axis.

In one optional embodiment, the control module 1620 is specifically configured to control, based on the drive signal, the rotor to reciprocate linearly or rotationally relative to the reference axis, so that the rotor vibrates, and/or the control module 1620 is specifically configured to control, based on the drive signal, the rotor to move away from the datum axis, and drive, by a reset mechanism, the rotor to move toward the datum axis, so that the rotor vibrates. The motor comprises the reset mechanism, and the reset mechanism is capable of resetting toward the datum axis.

In one optional embodiment, the control module 1620 is specifically configured to control, based on the drive signal, the rotor to vibrate relative to the reference axis at a predetermined amplitude, and controlling the reference axis to move to change the vibration center of the rotor. The predetermined amplitude of the rotor being less than the motion range of the reference axis. Alternatively, the control module 1620 is specifically configured to gradually increase the vibration amplitude of the rotor based on the drive signal, and change the position of the reference axis. Alternatively, the control module 1620 is specifically configured to gradually reduce the vibration amplitude of the rotor based on the drive signal, and changing the position of the reference axis.

In one optional embodiment, the control module 1620 is specifically configured to control, based on the drive signal, the rotation angle of the rotor away from the datum axis to be equal to the rotation angle of the rotor towards the datum axis, so that the rotor resets to a position of the datum axis after each of the reciprocating vibrations; and/or the control module 1620 is specifically configured to control, based on the drive signal, the rotation angle of the rotor away from the datum axis in the reciprocating vibrations of the rotor to be equal to the rotation angle of the rotor towards the datum axis, and keep the rotation angle of the rotor being unchanged, so that the rotor continuously vibrates relative to the reference axis at an equal angle when the reference axis remains unchanged.

In one optional embodiment, the control module 1620 is specifically configured to gradually increase, based on the drive signal, the distance or the rotation angle of the reference axis relative to the datum axis as vibration times of the rotor increase. Alternatively, the control module 1620 is specifically configured to gradually reduce, based on the drive signal, the distance or the rotation angle of the reference axis relative to the datum axis as the vibration times of the rotor increase. Alternatively, the control module 1620 is specifically configured to gradually increase, based on the drive signal, the distance or the rotation angle of the reference axis relative to the datum axis to a first predetermined distance or a first predetermined angle and then gradually reduce the distance or the rotation angle of the reference axis relative to the datum axis, as the vibration times of the rotor gradually increase.

In one optional embodiment, as the vibration times of the rotor gradually increase, the control module 1620 is specifically configured to gradually increase, based on the drive signal, the rotation angle of the reference axis relative to the datum axis to a second predetermined angle in a first direction, then gradually reduce the rotation angle of the reference axis relative to the datum axis in the first direction, gradually increase the rotation angle of the reference axis relative to the datum axis to a third predetermined angle in a direction opposite to the first direction, and gradually reduce the rotation angle of the reference axis relative to the datum axis in the direction opposite to the first direction.

In one optional embodiment, the control module 1620 is specifically configured to control, based on the drive signal, the rotation angle of the rotor towards the datum axis being unchanged during the reciprocating vibrations of the rotor, and/or the control module 1620 is specifically configured to control, based on the drive signal, the rotation angle of the rotor towards the datum axis being unchanged during the reciprocating vibrations of the rotor.

In one optional embodiment, the control module 1620 is specifically configured to control the rotation angle of the reference axis to change at a constant angle relative to the datum axis based on the drive signal.

In one optional embodiment, when the rotor is controlled to perform the reciprocating vibrations having different vibration amplitudes based on the vibration signals in each of the sweeping signals of the drive signal, the control module 1620 is specifically configured to control the vibration frequencies of the reciprocating vibrations being the same.

In one optional embodiment, when the rotor is controlled to perform the reciprocating vibrations having different vibration amplitudes based on the vibration signals in each of the sweeping signals of the drive signal, the control module 1620 is specifically configured to control the vibration frequencies of the reciprocating vibrations being different. The greater the vibration amplitude of the rotor during a single reciprocating vibration, the lower the vibration frequency.

In one optional embodiment, the motor comprises a limiter configured to limit a maximum motion range of the rotor.

In one optional embodiment, the rotor is reset to the same predetermined datum axis during the reciprocating vibrations.

In one optional embodiment, the drive signal comprises the sweeping signals, and each of the sweeping signals comprises the vibration signals. The control module 1620 is specifically configured to control the rotor to vibrate based on the vibration signals; control the rotor to vibrate based on the sweeping signals, and change the position of the reference axis to form the sweeping motion of the rotor.

In one optional embodiment, the control module 1620 is specifically configured to control the vibration frequency of the rotor based on the frequency of each of the vibration signals; and/or control the vibration amplitude of the rotor based on the duty ratio of each of the vibration signals; and/or control the sweeping amplitude of the reference axis based on the duration of the high levels and/or the duty ratio of each of the vibration signals within each of the sweeping signals; and/or control the sweeping speed (sweeping frequency) of the reference axis based on the duration of the high levels and/or the duty ratio and/or the frequency of each of the vibration signals within each of the sweeping signals.

In one optional embodiment, the control module 1620 is specifically configured to control the rotor to rotate in the first direction based on the high level of each of the vibration signals in each of the sweeping signals, and control the rotor to rotate in the direction opposite to the first direction based on the low level or the reverse high level of each of the vibration signals. Each of the sweeping signals is the periodic signal. The polarity of the vibration signals in the first half cycle of each of the sweeping signals is opposite to the polarity of the vibration signals in the second half cycle of each of the sweeping signals. The first half cycle and the second half cycle of each of the sweeping signals respectively control the reference axis to sweep on two sides of the datum axis.

In one optional embodiment, the first half cycle and the second half cycle of each of the sweeping signals are connected at a transition low level, and the total duration of the transition low level of each of the sweeping signals is greater than a predetermined duration.

In one optional embodiment, the waveform of the drive signal is one or more of a sine wave, a square wave, and a triangular wave. Optionally, the drive signal is an electrical signal.

In one optional embodiment, the rotor is controlled in an open-loop manner based on the drive signal.

In one optional embodiment, the drive signal comprises the sweeping signals, and each of the sweeping signals comprises the vibration signals. The control module 1620 is specifically configured to control the rotor to rotate in a first direction based on a high level of each of the vibration signals, and control the rotor to rotate in a direction opposite to the first direction based on a low level or a reverse high level of each of the vibration signals, so that the rotor vibrates back and forth relative to the reference axis. The control module 1620 is specifically configured to control the rotor to vibrate based on each of the sweeping signals and change the position of the reference axis to generate the sweeping motion of the rotor, so as to increase the vibration coverage range of the rotor.

In one optional embodiment, in each of the sweeping signals, the control module 1620 is specifically configured to control the rotor to rotate in the direction opposite to the first direction based on low levels and/or reverse high levels of each of the sweeping signals after controlling the rotor to rotate in the first direction based on the high level of each of the vibration signals of each of the sweeping signals. Further, the control module 1620 is specifically configured to control the rotor to rotate in the first direction again based on the high level of each of the vibration signals of each of the sweeping signals when a reverse rotation of the rotor is not in place, so as to change the rotation angle of the reference axis.

In one optional embodiment, the motor comprises a reset mechanism. The reset mechanism is configured to reset the rotor toward a datum axis. The datum axis is a fixed reference axis of the reciprocating vibrations of the rotor. The rotor moves in a direction away from the datum axis under a high level of each of the vibration signals. The reset mechanism drives the rotor to move in a direction toward the datum axis under a low level and/or a reverse high level of each of the vibration signals.

In one optional embodiment, the reset mechanism is a magnetic reset mechanism. The smaller the rotation angle of the reference axis relative to a datum axis, the longer the duration of the high level in each of the vibration signals when controlling the rotor to rotate at the same rotation angle away from the datum axis; and/or the smaller the rotation angle of the reference axis relative to the datum axis, the shorter the duration of the reverse high level in each of the vibration signals when controlling the rotor to rotate at the same rotation angle away from the datum axis. When the rotation angle of the reference axis relative to the datum axis is less than a second predetermined angle, the duration of the reverse high level in each of the vibration signals is 0.

In one optional embodiment, the reset mechanism is a magnetic reset mechanism. The smaller the rotation angle of the reference axis relative to the datum axis, the longer the duration of the high level in each of the vibration signals when controlling the rotor to rotate at the same rotation angle as the reference axis. The smaller the rotation angle of the reference axis relative to the datum axis, the shorter the duration of the reverse high level in each of the vibration signals when controlling the rotor to rotate at the same rotation angle as the reference axis. When the rotation angle of the reference axis relative to the datum axis is less than a second predetermined angle, the duration of the reverse high level in each of the vibration signals is 0.

In one optional embodiment, the high level of each of the vibration signals controls the rotor to move in the first direction, the low level of each of the vibration signals does not drive the rotor to move, and the reverse high level of each of the vibration signals controls the rotor to move in the direction opposite to the first direction. The pulse width of each of the vibration signals periodically change according to a rule of decreasing first and then decreasing. Optionally, each of the sweeping signals is a periodic signal, the polarity of the vibration signals in the first half cycle of each of the sweeping signals is opposite to the polarity of the vibration signals in the second half cycle of each of the sweeping signals, and the first half cycle and the second half cycle of each of the sweeping signals respectively control the reference axis to move on two sides of the datum axis. The first half cycle and the second half cycle of each of the sweeping signals are connected at a transition low level, and the total duration of the transition low level of each of the sweeping signals is greater than a predetermined duration. Alternatively, the first half cycle and the second half cycle of each of the sweeping signals are connected at a transition reverse high level, and the transition reverse high level of the sweeping signals makes the two ends of the motor short-circuited.

In one optional embodiment, the control module 1620 is specifically configured to vibrate the motor to generate sound based on an audio track drive signal, and the execution frequency of the audio track drive signal is controlled within a range of not less than 10 KHZ and not greater than 22.05 KHZ. Alternatively, the control module 1620 is specifically configured to vibrate the motor to generate sound based on the audio track drive signal, and the audio track drive signal is obtained by sampling an audio track signal input to the motor, and the sampling frequency during sampling determines the execution frequency of the audio track drive signal. The sampling frequency of the audio track signal is selected within the range of not less than 10 KHZ and not greater than 22.05 KHZ.

In one optional embodiment, when the vibration signals satisfy a first condition, the rotation angle of the rotor away from the datum axis under a high level of each of the vibration signals is greater than the rotation angle of the rotor towards the datum axis under a low level and/or a reverse high level of each of the vibration signals. Optionally, when the vibration signals satisfy a second condition, the rotation angle of the rotor away from the datum axis under the high level of each of the vibration signals is less than the rotation angle of the rotor towards the datum axis under the low level and/or the reverse high level of each of the vibration signals, so that the reference axis rotates toward the datum axis.

In one optional embodiment, each of the vibration signals of the sweeping signals sequentially satisfies the first condition before satisfying the second condition. Each of the sweeping signals is a periodic signal, and the polarity of the vibration signals in the first half cycle of each of the sweeping signals is opposite to the polarity of the vibration signals in the second half cycle of each of the sweeping signals. In the first half cycle, the vibration signals in each of the sweeping signals satisfy the first condition in sequence and then satisfy the second condition. In the second half cycle, the vibration signals in each of the sweeping signals satisfy the first condition in sequence and then satisfy the second condition.

In one optional embodiment, frequencies of the vibration signals in each of the sweeping signals are the same; or, the frequencies of the vibration signals in each of the sweeping signals are different; and/or, the duration of the high levels of the vibration signals in each of the sweeping signals is the same or gradually increases or decreases in sequence, and/or, the duration of the low levels of the vibration signals in each of the sweeping signals is the same or gradually increases or decreases in sequence, and/or, the duration of the reverse high levels of the vibration signals in each of the sweeping signals is the same or gradually increases or decreases in sequence; and/or, each of the vibration signals in each of the sweeping signals is repeated continuously for multiple times; and/or, the rotation angle of the reference axis relative to the datum axis changes at an equal angle; and/or, when the rotor vibrates with different vibration amplitudes, the frequencies of the vibration signals are different; the lower the frequency of each of the vibration signals, the greater the vibration amplitude of the rotor when it vibrates; and/or, the motor comprises a limiter, and the limiter is configured to limit the maximum motion range of the rotor; and/or, the rotor is reset to the same predetermined datum axis each time it vibrates, and the datum axis is a fixed reference axis for the motion of the rotor.

The division of modules in the motor control device of the oral care device is provided for illustrative purposes only. In other embodiments, the motor control device of the oral care device may be divided into different modules as needed to complete all or part of the functions of the motor control device of the oral care device. The modules in the motor control device of the oral care device provided in the embodiments of the present disclosure may be a computer program. The computer program may be run on the oral care device. Program modules constituted by the computer program may be stored in a memory of the oral care device. When the computer program is executed by a processor, all or part of the steps of the control method for the motor of the oral care device described in the embodiments of the present disclosure are implemented.

FIG. 17 is a block schematic diagram of the oral care device according to one embodiment of the present disclosure. As shown in FIG. 17, the oral care device 1700 comprises at least one processor 1710, a network interface 1720, a user interface 1730, a memory 1740, a motor 1750, and at least one communication bus 1760.

The at least one communication bus 1760 is configured to achieve connection and communication between the various components of the oral care device 1700.

Optionally, the network interface 1720 comprises a BLUETOOTH module, a near field communication (NFC) module, a wireless fidelity (WI-FI) module, etc.

The user interface 1730 comprises a display screen and a camera. Optionally, the user interface 1730 may further comprise a standard wired interface and a wireless interface.

The motor 1750 comprises a rotor and is configured to control the rotor to vibrate based on a drive signal.

The at least one processor 1710 comprises one or more processing cores. The at least one processor 1710 uses various interfaces and lines to connect various parts of the oral care device 1700. The processor 1710 executes various functions and processes data of the oral care device 1700 by running or executing instructions, programs, code sets or instruction sets stored in the memory 1740, and calling data stored in the memory 1740. Optionally, the at least one processor 1710 is implemented by at least one hardware of a digital signal processing (DSP), a field programmable gate array (FPGA), and a programmable logic array (PLA). The at least one processor 1710 may integrate one or a combination of a central processing unit (CPU), a graphics processing unit (GPU), and a modem. The CPU mainly processes an operating system and an application for the oral care device 1700. The GPU is responsible for rendering and drawing content to be displayed on the display screen. The modem is configured to process wireless communications. It is understood that the modem may not be integrated into the at least one processor 1710, but implemented by a chip.

The memory 1740 may be a random access memory (RAM) or a read-only memory (ROM). Optionally, the memory 1740 may be a non-transitory computer-readable medium. The memory 1740 is configured to store the instructions, the programs, the codes, the code sets or the instruction sets. The memory 1740 comprises a program storage area and a data storage area. The program storage area stores the instructions for implementing the operating system, the instructions for at least one function (such as a receiving function, a control function, a determination function, etc.), the instructions for implementing the controls method of the present disclosure, etc. The data storage area stores data involved in the control method of the present disclosure, etc. Optionally, the memory 1740 may be at least one storage device located away from the at least one processor 1710. As shown in FIG. 17, the memory 1740 served as a computer storage medium may comprise the operating system, a network communication module, a user interface module, and program instructions.

In one optional embodiment, the at least one processor 1710 is configured to call the program instructions stored in the memory 1740 to execute the control method described in the above embodiments.

The embodiments of the present disclosure further provide a computer storage medium, and the instructions are stored in the computer storage medium. When the instructions are executed on a computer or the at least one processor, the computer or the at least one processor executes one or more steps of the control method in any of the embodiments. When component modules of the control method for the motor of the oral care device are implemented in a form of software functional units and are sold or used as an independent product, the component modules are stored in the computer storage medium.

In the above embodiments, the present disclosure may be implemented in whole or in part by software, hardware, firmware or any combination thereof. When implemented by software, the software is implemented in whole or in part in a form of a computer program product. The computer program product comprises one or more computer instructions. When the one or more computer program instructions are loaded and executed on the computer, the process or function described in the embodiments of the present disclosure is generated in whole or in part. The computer may be a general-purpose computer, a special-purpose computer, a computer network, or other programmable device. The one or more computer instructions may be stored in the computer-readable storage medium or transmitted through the computer-readable storage medium. The one or more computer instructions may be transmitted from a website site, a computer, a server, or a data center to another website site, another computer, another server or another data center by wired (e.g., coaxial cable, optical fiber, digital subscriber line) or wireless (e.g., infrared, wireless, microwave, etc.) mode. The computer-readable storage medium may be any available medium that is able to be accessed by the computer or a data storage device such as the server or the data center that comprises one or more available media integrated. The one or more available media may be a magnetic medium (e.g., a floppy disk, a hard disk, a magnetic tape), an optical medium (e.g., a digital versatile disc (DVD)), or a semiconductor medium (e.g., a solid state disk (SSD)).

Those skilled in the art can understand that all or part of the processes in the above-mentioned embodiments can be implemented by instructing the relevant hardware through the computer programs, and the computer programs may be stored in the computer-readable storage medium. When the computer programs are executed, the processes of the embodiments of the present disclosure are executed. The storage medium comprises the ROM, the RAM, a magnetic disk, an optical disk, or other media that are able to store the program codes. In the absence of conflict, the technical features in the embodiments and implementation schemes of the present disclosure can be combined arbitrarily.

The above embodiments are merely illustrative of the optional embodiments of the present disclosure and are not intended to limit the scope of the present disclosure. Various modifications and improvements made by those of ordinary skill in the art to the technical solutions of the present disclosure shall fall within the protection scope defined by the claims of the present disclosure without departing from the spirit of the present disclosure.

What is claimed is:

1. A control method for a motor of an oral care device, comprising steps:
obtaining a drive signal, wherein the drive signal comprises sweeping signals, and each of the sweeping signals comprises vibration signals;
controlling a rotor of the motor to perform reciprocating vibrations relative to a reference axis based on the drive signal, and changing a position of the reference axis to increase a vibration coverage range of the rotor, wherein the reciprocating vibrations comprise linear vibrations or rotational vibrations; and
controlling the rotor to vibrate based on the vibration signals, controlling the rotor to vibrate based on the sweeping signals, and changing the position of the reference axis to form a sweeping motion of the rotor;
wherein the drive signal is a predetermined signal.

2. The control method according to claim 1, wherein the step of controlling the rotor of the motor to perform the reciprocating vibrations relative to the reference axis based on the drive signal, and changing the position of the reference axis to increase the vibration coverage range of the rotor comprises steps:
controlling the rotor to move in a first direction; and
controlling the rotor to move in the first direction again to change the position of the reference axis when a reverse motion of the rotor in a direction opposite to the first direction is not in place.

3. The control method according to claim 2, wherein the control method further comprises a step:
controlling the reference axis to rotate relative to a datum axis based on the drive signal;
wherein the datum axis is a fixed reference axis of motion of the rotor, and the first direction comprises a rotation direction toward the datum axis or a rotation direction away from the datum axis.

4. The control method according to claim 3, wherein the step of controlling the reference axis to rotate relative to the datum axis based on the drive signal comprises steps:
controlling, based on the drive signal, a rotation angle of the rotor toward the datum axis to be greater than a rotation angle of the rotor away from the datum axis when the rotor is controlled to vibrate, so that the reference axis rotates toward the datum axis; and/or
controlling the rotation angle of the rotor away from the datum axis to be greater than the rotation angle of the rotor toward the datum axis when the rotor is controlled to vibrate, so that the reference axis rotates away from the datum axis.

5. The control method according to claim 1, wherein controlling the rotor of the motor to perform the reciprocating vibrations relative to the reference axis based on the drive signal comprises steps:
controlling, based on the drive signal, the rotor to reciprocate linearly or rotationally relative to the reference axis, so that the rotor performs the reciprocating vibrations; and/or
controlling, based on the drive signal, the rotor to move away from the datum axis, and driving, by a reset mechanism, the rotor to move toward the datum axis, so that the rotor performs the reciprocating vibrations;;
wherein the motor comprises the reset mechanism, and the reset mechanism is configured to reset the rotor toward a datum axis.

6. The control method according to claim 1, wherein the control method further comprises a step:
controlling, based on the drive signal, the rotor to vibrate relative to the reference axis at a predetermined vibration amplitude, and controlling the reference axis to move to change a vibration center of the rotor; wherein the predetermined vibration amplitude of the rotor is less than a motion range of the reference axis; or
gradually increasing a vibration amplitude of the rotor based on the drive signal, and changing the position of the reference axis; or
gradually reducing the vibration amplitude of the rotor based on the drive signal, and changing the position of the reference axis.

7. The control method according to claim 6, wherein the control method further comprises steps:
controlling, based on the drive signal, a rotation angle of the rotor away from the datum axis to be equal to a rotation angle of the rotor towards the datum axis, so that the rotor resets to a position of the datum axis after each of the reciprocating vibrations; and/or
controlling, based on the drive signal, the rotation angle of the rotor away from the datum axis in continuous vibrations of the rotor to be equal to the rotation angle of the rotor towards the datum axis, and keeping the rotation angle of the rotor being unchanged, so that the rotor continuously vibrates relative to the reference axis at an equal angle when the reference axis remains unchanged.

8. The control method according to claim 1, wherein the control method further comprises steps:
gradually increasing, based on the drive signal, a distance or a rotation angle of the reference axis relative to a datum axis as vibration times of the rotor increase; or
gradually reducing, based on the drive signal, the distance or the rotation angle of the reference axis relative to the datum axis as the vibration times of the rotor increase; or
gradually increasing, based on the drive signal, the distance or the rotation angle of the reference axis relative to the datum axis to a first predetermined distance or a first predetermined angle and then gradually reducing the distance or the rotation angle of the reference axis relative to the datum axis, as the vibration times of the rotor increase.

9. The control method according to claim 8, wherein the control method further comprises a step:
as the vibration times of the rotor increase, gradually increasing, based on the drive signal, the rotation angle of the reference axis relative to the datum axis to a second predetermined angle in a first direction, then gradually reducing the rotation angle of the reference axis relative to the datum axis in the first direction, gradually increasing the rotation angle of the reference axis relative to the datum axis to a third predetermined angle in a direction opposite to the first direction, and gradually reducing the rotation angle of the reference axis relative to the datum axis in the direction opposite to the first direction.

10. The control method according to claim 4, wherein the control method further comprises:
controlling, based on the drive signal, the rotation angle of the rotor towards the datum axis being unchanged during the reciprocating vibrations of the rotor, and/or
controlling, based on the drive signal, the rotation angle of the rotor away from the datum axis being unchanged during the reciprocating vibrations of the rotor.

11. The control method according to claim 1, wherein the control method further comprises:
controlling the rotor to rotate in a first direction based on a high level of each of the vibration signals in the sweeping signals, and
controlling the rotor to rotate in a direction opposite to the first direction based on a low level or a reverse high level of each of the vibration signals;
wherein each of the sweeping signals is a periodic signal, a polarity of the vibration signals in a first half cycle of each of the sweeping signals is opposite to a polarity of the vibration signals in a second half cycle of each of the sweeping signals, and the first half cycle and the second half cycle of each of the sweeping signals respectively control the reference axis to sweep on two sides of a datum axis.

12. The control method according to claim 1, wherein a waveform of the drive signal is one or more of a sine wave, a square wave, and a triangular wave; and/or
the drive signal is an electrical signal; and/or
an open loop control is formed on the rotor of the motor based on the drive signal.

13. The control method according to claim 1, wherein the step of controlling the rotor of the motor to perform the reciprocating vibrations relative to the reference axis based on the drive signal, and changing the position of the reference axis to increase the vibration coverage range of the rotor comprises steps:
controlling the rotor to rotate in a first direction based on a high level of each of the vibration signals, and controlling the rotor to rotate in a direction opposite to the first direction based on a low level or a reverse high level of each of the vibration signals, so that the rotor performs the reciprocating vibrations relative to the reference axis; and
controlling the rotor to vibrate based on each of the sweeping signals, and changing the position of the reference axis to generate the sweeping motion of the rotor, so as to increase the vibration coverage range of the rotor.

14. The control method according to claim 12, wherein the step of controlling the rotor to vibrate based on the sweeping signals, and changing the position of the reference axis to generate the sweeping motion of the rotor, so as to increase the vibration coverage range of the rotor comprises steps:
in each of the sweeping signals, controlling the rotor to rotate in the direction opposite to the first direction based on a low level of a current vibration signal and/or a reverse high level of the current vibration signal after controlling the rotor to rotate in the first direction based on a high level of the current vibration signal; and
controlling the rotor to rotate in the first direction again based on a high levels of a next vibration signal when a rotation of the rotor in the direction opposite to the first direction is not in place, so as to change a rotation angle of the reference axis.

15. The control method according to claim 12, wherein the motor comprises a reset mechanism, the reset mechanism is configured to reset the rotor toward a datum axis, and the datum axis is a fixed reference axis of the reciprocating vibrations of the rotor;
the rotor moves in a direction away from the datum axis under a high level of each of the vibration signals; and
the reset mechanism drives the rotor to move in a direction toward the datum axis under a low level and/or a reverse high level of each of the vibration signals.

16. The control method according to claim 14, wherein the reset mechanism is a magnetic reset mechanism;
wherein the smaller the rotation angle of the reference axis relative to a datum axis, the longer a duration of the high level in each of the vibration signals when controlling the rotor to rotate at a fixed rotation angle away from the datum axis; and/or
the smaller the rotation angle of the reference axis relative to the datum axis, the shorter a duration of the reverse high level in each of the vibration signals when controlling the rotor to rotate at a fixed rotation angle away from the datum axis;
wherein when the rotation angle of the reference axis relative to the datum axis is less than a second predetermined angle, the duration of the reverse high level in each of the vibration signals is 0.

17. The control method according to claim 12, wherein a high level of each of the vibration signals controls the rotor to rotate in a first direction, a low level of each of the vibration signals does not drive the rotor to move, and a reverse high level of each of the vibration signals controls the rotor to rotate in a direction opposite to the first direction; and/or
pulse widths of the vibration signals periodically change according to a rule of increasing first and then decreasing; and/or
each of the sweeping signals is a periodic signal, a polarity of the vibration signals in a first half cycle of each of the sweeping signals is opposite to a polarity of the vibration signals in a second half cycle of each of the sweeping signals, and the first half cycle and the second half cycle of each of the sweeping signals respectively control the reference axis to move on two sides of the datum axis;
wherein the first half cycle and the second half cycle of each of the sweeping signals are connected at a transition low level, and a total duration of the transition low level of each of the sweeping signals is greater than a predetermined duration; or
the first half cycle and the second half cycle of each of the sweeping signals are connected at a transition reverse high level, and the transition reverse high level of each of the sweeping signals makes two ends of the motor short-circuited.

18. The control method according to claim 12, wherein when the vibration signals satisfy a first condition, a rotation angle of the rotor away from the datum axis under a high level of each of the vibration signals is greater than the rotation angle of the rotor towards the datum axis under a low level and/or a reverse high level of each of the vibration signals; and/or
when the vibration signals satisfy a second condition, the rotation angle of the rotor away from the datum axis under the high level of each of the vibration signals is less than the rotation angle of the rotor towards the datum axis under the low level and/or the reverse high level of each of the vibration signals, so that the reference axis rotates toward the datum axis.

19. The control method according to claim 1, wherein the control method further comprises steps:
controlling a vibration frequency of the rotor based on a frequency corresponding to each of the vibration signals; and/or,
controlling a vibration amplitude of the rotor based on a duty ratio corresponding to each of the vibration signals; and/or,
controlling a sweeping amplitude of the reference axis based on at least one of a duration of a high level in each of the vibration signals of each of the sweeping signals and the duty ratio corresponding to each of the vibration signals of each of the sweeping signals; and/or
controlling a sweeping frequency of the reference axis based on at least one of the duration of the high level in each of the vibration signals of each of the sweeping signals, the duty ratio corresponding to each of the vibration signals of each of the sweeping signals, and the frequency corresponding to each of the vibration signals.

20. An oral care device, comprising:
a motor;
wherein the motor comprises a rotor;
wherein the oral care device is configured to:
obtain a drive signal, wherein the drive signal comprises sweeping signals, and each of the sweeping signals comprises vibration signals;
control the rotor of the motor to perform reciprocating vibrations relative to a reference axis based on the drive signal, and change a position of the reference axis to increase a vibration coverage range of the rotor; wherein the reciprocating vibrations comprise linear vibrations or rotational vibrations; and
control the rotor to vibrate based on the vibration signals, control the rotor to vibrate based on the sweeping signals, and change the position of the reference axis to form a sweeping motion of the rotor.
